(19) United States
(12) Patent Application Publication
(10) Pub. No.: US 2015/0302084 A1
(43) Pub. Date: Oct. 22, 2015

(54) DATA MINING APPARATUS AND METHOD

(71) Applicant: Robert STEWART, Arlington, VA (US)

(72) Inventors: Robert Stewart, Arlington, VA (US); Martin THURN, Ashburn, VA (US)

(73) Assignee: Robert STEWART, Arlington, VA (US)

(21) Appl. No.: 14/689,549

(22) Filed: Apr. 17, 2015

Related U.S. Application Data
(60) Provisional application No. 61/980,820, filed on Apr. 17, 2014.

(51) Int. Cl. G06F 17/30

(52) U.S. Cl. CPC G06F 17/30722; G06F 17/30011; G06F 17/30675; H04N 1/04

(57) ABSTRACT

A data mining apparatus and method are provided. The method operates by receiving a keyword list, compiling the keyword list into a finite state machine (FSM), performing data mining on documents in a document repository using a scanner, wherein the scanner uses the FSM to produce a match list comprising information about locations of the keywords in the documents, and processing the match list to produce a grid document comprising information about co-occurrences of keywords from the list in the documents. The apparatus uses a compiler, a scanner, and a builder to implement the method.

### CROSS-REFERENCE TO RELATED APPLICATIONS

This application claims the benefit under 35 U.S.C. §119(e) of U.S. Provisional Application No. 61/980,820 filed on Apr. 17, 2014, the entire disclosure of which is incorporated herein by reference for all purposes.

### BACKGROUND

1. Field

The following description relates to a data mining apparatus and a data mining method. The following description further relates to data mining of large repositories of text information to search, mine, store, and extract relevant and refined information from large repositories of text information and to visualize such information.

2. Description of Related Art

In many fields, large repositories of data exist in various forms, including various hard copy records such as microfiche or paper records, and various digital formats such as text, markup languages, image formats, PDF, DOC, or legacy formats. These data repositories, when considered and analyzed, include large amounts of valuable information that can be derived by considering the relationships between pieces of information in the data repositories. Furthermore, it is possible to organize and visualize such valuable information in various ways that improve the ability to understand and apply such conclusions.

However, several problems interfere with the ability of users of such data repositories to successfully derive and utilize such conclusions. First, data mining often involves processing tremendous quantities of information. For example, hundreds of gigabytes or even terabytes of data may be relevant to a given data mining task. In addition to the sheer amounts of data, the amounts of processing power required to analyze and compare these large amounts of data is also quite large. Furthermore, due to the need to compare multiple pieces of information with one another, processing requirements may grow faster than other requirements like the amount of storage required to store and archive the data that is to be mined. In addition to processing power and storage requirements, data mining may also require large amounts of other resources, such as network bandwidth or electrical power.

Second, there are often issues in gathering and organizing the information that is to be used into a standardized format. In order to perform data mining, the data that is to be mined should be in a format, such as text or markup language, that allows the information to be processed as characters, where the characters form words. Such formatting is known as normalization, and normalization is necessary because simply comparing images of documents is not an efficient way to extract relationships between pieces of data that are mined, because the relevant relationships are generally based on the textual content in the documents rather than visual content of the documents. To gather the information, it is necessary to scan information that is not already digitized and process such scanned information along with information that is not already normalized, such as images, and use OCR technologies to transform such documents into normalized documents that can be analyzed.

Third, it can be difficult for a user to effectively define what types of relationships are desired. Even if a technology is able to address the above problems, a data mining technology needs to be able to allow a user to effectively input and define criteria that allow data mining technology to use when processing the data so as to facilitate effectively and conveniently defining which aspects of the data to be mined are of interest to the user. As a related issue, a data mining technology requires a mechanism for effectively presenting the conclusions it derives.

For example, such data mining technology is potentially applicable to many areas where large amounts of information exist, where ascertaining that relationships exist between such pieces of information is valuable. For example, health care, finance, and many other fields are potential beneficiaries of such technology. However, as one particular example of a field where data mining is useful is the energy field. In this field, various legal documents include information about the existence and transference of mineral rights. Analyzing the content and relationships between terms included in such legal documents potentially offers the ability to derive meaningful conclusions to aid business decision-marking in the energy field. However, at present, no technologies provide ways to effectively exploit the value of such information in this field. Due to the issues discussed above with gathering, processing, and applying such information, it may be difficult to effectively exploit information using these approaches.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In general, examples are directed to using proprietary technologies that include hardware components structured to implement certain mathematical formulas, algorithms, and technologically-based processes to search, mine, store, and extract relevant and refined information from large repositories of text data.

In one general aspect, a data mining method includes receiving a keyword list, compiling the keyword list into a finite state machine (FSM), performing data mining on documents in a document repository using a scanner, wherein the scanner uses the FSM to produce a match list comprising information about locations of the keywords in the documents, and processing the match list to produce a grid document comprising information about co-occurrences of keywords from the list in the documents.

The keyword list may include regular expressions.

The compiling may include transforming the keyword list into FSM bytecode and storing a representation of the FSM in memory based on the bytecode.

The scanner may use the FSM to produce a match list by processing each character in the documents to follow transitions in the FSM, and may output match information when the current state in the FSM is an end state.

An end state may indicate a keyword boundary, a paragraph boundary, or a document boundary.

The match information may include location information about where in the documents the match occurred.

The processing of the match list may include generating a list of co-occurrences and counts co-occurrences to generate information for the grid.

The grid may present visual information indicative of the level of frequency of co-occurrences between keywords from the keyword list.

The grid may include graphical elements that provide a user with links to locations in the documents where co-occurrences occur.

The scanner may require only a single pass through the documents to produce the match list.

In another general aspect, a data mining apparatus includes a compiler configured to receive a keyword list and to compile the keyword list into a finite state machine (FSM), a scanner configured to perform data mining on documents in a document repository, wherein the scanner uses the FSM to produce a match list comprising information about locations of the keywords in the documents, and a builder configured to process the match list to produce a grid document comprising information about co-occurrences of keywords from the list in the documents.

The keyword list may include regular expressions.

The compiler may transform the keyword list into FSM bytecode and may store a representation of the FSM in memory based on the bytecode.

The scanner may use the FSM to produce a match list by processing each character in the documents to follow transitions in the FSM, and may output match information when the current state in the FSM is an end state.

An end state may indicate a keyword boundary, a paragraph boundary, or a document boundary.

The match information may include location information about where in the documents the match occurred.

The builder may process the match list to generate a list of co-occurrences and may count co-occurrences to generate information for the grid.

The grid may present visual information indicative of the level of frequency of co-occurrences between keywords from the keyword list.

The grid may include graphical elements that provide a user with links to locations in the documents where co-occurrences occur.

In another general aspect, a non-transitory computer-readable storage medium may store a program for data mining, the program comprising instructions for causing a processor to perform the method presented above.

For example, an application of these text processing capabilities organizes and processes large quantities of documents related to the energy industry. For example, informational data, including text and numerical data, are ingested from archived collections of land deeds, land titles, mineral asset documents, and other large repositories of text such as medical records, insurance documents, and other similar types of records. In accord with an example, a method or a process is applied to scan and organize this collection of data to produce a visualization of co-occurrences of terms in a matrix format. The process then extracts the relevant intersections of data, which are then located and stored in a database for further analysis. This process is called the TextOre Information Refinery. At present, large amounts of data, such as mineral rights information, exist in currently irretrievable formats, such as handwritten documents, poorly scanned or photocopied data, etc., dispersed throughout local repositories.

TextOre is sophisticated proprietary software that is unlike other technologies currently available. It has the ability to perform searches that are highly detailed using multiple queries in multiple languages. At the same time, TextOre provides results in a very easily understood manner. Results are provided through an advanced visualization profiling tool that identifies and visually depicts the intensity of relationships in unstructured data sources, such as letters, documents, e-mail, web blogs, social media, and web pages, and also including real-time news and information feeds. The technology not only identifies anomalies, frequently missed by competitive technologies, but also identifies specific sentences, paragraphs and relationships where terms co-occur, taking into account the precise terms applied by a user.

The method and apparatus convert and mine this data and have the ability to search, identify, store, and extract critical data in real time from multiple sources. The critical data may include, but it is not limited to, static data such as local records, streaming news and information from global sources, multi-language and multi-source origins.

In accordance with an illustrative example, the method and apparatus are potentially implemented to process and data mine information associated with land deeds and related documents at county courthouses in a country, such as the United States of America, to find the incidence of ownership of oil, gas and mineral rights by the names of owners, tract size, acreage, geographical location, etc. The apparatus and method use proprietary algorithms, discussed further below, to locate relevant information from within this large collection of text information, extract relevant data elements, and display the results in a visualization tool. In accordance with an example, the apparatus and method then produce a database of results for an end user to use for various applications.

Other features and aspects will be apparent from the following detailed description, the drawings, and the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a diagram illustrating an example of an Information Refinery apparatus.

FIGS. 2A-2B are screenshots illustrating examples of handwriting recognition.

FIG. 3 is another screenshot illustrating an example of handwriting recognition.

FIG. 4 is a set of screenshots illustrating an example of entry of key terms.

FIG. 5 is a screenshot illustrating a results overview.

FIG. 6 is a screenshot illustrating an example of an Input Stage for key terms.

FIG. 7 is a screenshot illustrating an example of First Level Analysis.

FIG. 8 is a screenshot illustrating an example of Second Level Analysis.

FIG. 9 is a screenshot illustrating an example of Text Extraction.

FIG. 10 is a screenshot illustrating an example of use of multilingual key terms.

FIG. 11 is a screenshot illustrating an example of use of multilingual key terms in a results overview.

FIG. 12 is a screenshot illustrating an example of a scanned document.

FIG. 13 is a screenshot illustrating an example of a normalized version of the scanned document of FIG. 12.

FIG. 14 is a screenshot illustrating a document with highlighted key terms.

FIG. 15 is a screenshot illustrating results in data table format.

FIG. 16 is a flowchart illustrating a method of gathering and normalizing information for data mining.

FIG. 17 is a diagram illustrating elements that perform a method of data mining of information gathered using the method of FIG. 16.

FIG. 18 is a diagram illustrating elements that perform a method of presenting and analyzing information derived using the method of FIG. 16.

FIG. 19 is a diagram illustrating a sample of a finite state machine (FSM) that is used to mine the data to produce a match list.

FIG. 20 is an example of how a match list is represented.

FIG. 21 is a flowchart illustrating the operational method of a scanner, according to an example.

FIG. 22 is a flowchart illustrating the operational method of a builder, according to an example.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

At a general level, there is provided an apparatus and a method to ingest large amounts of text and image data, such as data including 300 GB or more information, stored in microfiche and in other image formats (TIFF, PDF, JPEG, etc.) An apparatus and a method are provided to extract, collect, and store this data in a central repository from multiple physical sites and in multiple file formats (TIFF, PDF, JPEG, etc.) An apparatus and a method are provided to convert the microfiche or other image files into a standardized format for computer processing by performing normalization of data. This involves using standard commercial software such as ABBYY Fine Reader to convert the TIFF, JPEG, or other images to PDF for further processing and refinement. Subsequently, an apparatus and a method are provided to convert the “normalized” PDF files into HTML for use with the TextOre processes.

As is discussed further, below, an apparatus and a method are provided to efficiently identify key data elements from within the normalized collection of documents and text or other data, potentially in both structured and unstructured formats. As part of this process, an apparatus and a method are provided to enter key concepts, such as words, phrases, expressions, numbers, geographical coordinates, etc., into the TextOre process engine to identify where certain concepts or phrases occur within the collection of data or documents. An apparatus and a method are provided in TextOre to identify where two or more concepts intersect or occur within a designated proximity to each other, such as in the same sentence or paragraph or even within the same document.

Through use of key words, phrases, or expressions, and a set of documents to be analyzed as inputs, an apparatus and a method are provided to produce a visualization matrix showing how often each combination of keywords or phrases are associated in the analyzed set of documents. Additionally, an apparatus and a method are provided to produce an easily accessed database that houses all relevant data for data mining, such as in a field of use of oil and mineral rights information.

To facilitate these aspects of examples, an apparatus and a method are provided to digitize large quantities of physically housed data for the purposes of mining relevant data and information.

Thus, a data mining apparatus and a data mining method are described to ingest, search, mine, store, and display relevant results in a series of visualization displays for large volumes of unstructured text. For example, such documents may include medical documents, land deeds, county and state level records, and other collections of documents or files. In accordance with an illustrative configuration, the apparatus and the method apply a proprietary set of processes to the mining of this information to produce search results of only the most relevant data from within large amounts of unstructured text. This process is defined as an Information Refinery method and apparatus.

In an example field of use corresponding to energy information, the Information Refinery mines information, such as land deed records from county repositories. Such information, in an example, provides information about oil and gas deposits. However, beyond information about such oil and gas deposits that is literally presented in the documents, other information is potentially derived by comparing and analyzing different parts of the documents, either by comparing different parts of a single document, or different parts of the same document. For example, when certain terms or keywords co-occur in certain ways in documents, such a co-occurrence is a signal that such a document is relevant to the user's needs.

In the Information Refinery, an initial problem that the Information Refinery confronts is the process of ingesting data. The examples of the Information Refinery offer capabilities related to generalized processing of data, as well as specialized adaptations to particular fields of use.

In general, the problem that the Information Refinery confronts is the “Needle in a Hay Stack” problem that occurs when processing and searching through large amounts of information, where certain portions of the information are highly germane and relevant, but such information is embedded in large quantities of information that are not particularly relevant or helpful to a particular user's needs.

There are many internet search engines, such as Google Search, Yahoo Search, and Bing Search that crawl the web to find web pages that are relevant to particular search strings. However, the present examples are directed to a different type of data mining. Rather than identifying web pages that are related to a broad search string, examples are directed to a different level of granularity, in which relationships and contexts found in the body of documents are considered and analyzed with respect to individual terms in documents accompanying one another, rather than merely determining which documents and web pages are related to a search string. By considering documents at this level of granularity, examples are able to go beyond simply determining which documents are worthy of consideration as a whole, and establish which documents include portions that satisfy certain criteria that cause them to be of interest to a user.

Search engines are most helpful for searching general information on the web, such as where the next Rolling Stones concert will be played. Search engines are based on entering one or another small number of key words and the search terms are compared against an indexed listing of documents that contain that same word or words. Such a search approach is like looking at a phone book, in that the user knows that he or she wants to find a Chinese restaurant, so the search engine identifies all places on the web with the word “restaurant” or “Chinese” and then provides a listing. The problem is the search engine will return hundreds or thousands of “hits”, but there is limited information to help establish where the relevant data in the search results might exist. The user misses much of the information and may not ever find what he or she is looking for. A potentially massive list of results is produced, but there is often a very large quantity of information that is buried in the list. Most users do not go beyond the first 5 or 10 listings of hits before tiring of the search experience. Hence, other hits that are potentially more useful due to higher relevancy are not considered because there is no efficient way to access them.

Additionally, with other search engines such as Google, Bing, and Lucene, the search engine decides which keywords are more important. However with TextOre, the user determines which keywords are more important. For example, consider a use case of a user who is following information about beef cows in Europe. In such a situation, the user's keywords would be a list of names of European countries and cities, and a list of beef terminology. If the user enters all these keywords into a Lucene search interface, the results will be millions of documents that are tangential because the results may be directed to many web pages mentioning many European countries on many topics other than beef or many aspects of beef production that does not necessarily occur in Europe. These irrelevant pages clutter the search results, but they are potentially retrieved due to the way the pages are indexed, such as due to the number of different countries mentioned on the page. With TextOre, on the other hand, using the grid display the user can immediately focus on the beef terminology, and see what countries happen to co-occur with those keywords.

Thus, in contrast to other search engines, TextOre allows the user to enter hundreds or even thousands of concepts or search terms in multiple languages and “mines” the results as a series of patterns within documents or text data. As is discussed further, the concepts are represented using a special data structure that allows all of the terms to be considered simultaneously during one pass through the documents, allowing highly efficient term identification that rapidly and efficiently provides useful results. These patterns are cross-referenced in a unique visualization through a matrix, allowing the user to identify specifically what they are looking for in real time. TextOre offers a much higher level of granularity in refining the information to display specifically what the user is looking for through his or her search.

Furthermore, examples are able to provide visualizations and otherwise present such documents in a way that allows users to view, navigate, organize, and interpret documents based on key terms that indicate when a document is likely to be relevant to the interests and needs of a user. For example, examples consider how often certain terms appear in documents together. Making such a determination potentially leads to useful conclusions about not only which documents are likely to be useful, but why they are likely to be useful and which portions of useful documents play a role in the importance of a document. Such visualizations also aid users in considering large amounts of information using a conceptual framework that would not be possible using only textual features.

When processing information, examples use approaches where components implement algorithms to analyze the information that operate by considering the information at many levels, using a staged approach. By doing so, such approaches often discover aspects of data not unearthed by a conventional search engine or other conventional approaches to analyzing information. These approaches are discussed further, below.

The ability to derive such information from such data mining is potentially useful in many fields of application. For example, in oil and energy markets, the ability to quickly and accurately assess which real estate properties have potential mineral deposits and how to acquire and exploit the purchase of mineral rights upon or within targeted and specified drilling or extraction sites can provide major financial advantages. At present, determining which properties are most relevant is conducted in an inefficient manner, where an energy company sends “landmen” that are trained in property law and the energy business, who then go to county records offices or county clerks offices, where they subsequently review county or local records in order to identify properties and mineral titles for acquisition by energy companies. However, the use of “landmen” is inefficient and of limited efficacy due to problems with successfully accessing and analyzing the necessary documents. Hence, automating such analysis is a helpful way to mine such data for useful conclusions. However, examples do not merely reproduce the analysis tasks performed by landmen, but leverage technology in multiple ways to facilitate different aspects of the process of data mining, so that while examples achieve the results that landmen do, they also provide additional tangible results not available only through the use of landmen, and also process, analyze, and sort the documents in technologically supported ways that go beyond the simple reading and consideration performed by landmen, in that landmen read documents and use intuitive approaches to identify potentially valuable information related to mineral titles, while examples use components structured to implement certain algorithms and thereby systematically determine which documents are most likely to be useful.

One preliminary issue that occurs during automating analysis of documents to derive useful conclusions is the different documents to be considered are initially held by a wide variety of sources, in a wide variety of formats. However, in general having access to the widest variety of source documents will provide the most accurate results. However, as discussed above, examples require data in some format that allows characters and words present in the data to be recognized as text, such as if characters are represented by a scheme such as ASCII or Unicode.

However, many documents are not even represented in a digital form. Such documents may be stored in various physical formats. For example, the physical formats may be some form of paper documents or microfiche. Additionally, the physical forms may include mechanically printed text, handwritten printed text, or handwritten cursive text.

To acquire such data, it is necessary to transform the document into a digital, computerized format. The apparatus using a receiver, a collector, or a controller and the method thereof acquire the data, for example, land deeds and lease records, in a format to be standardized. Such documents, are stored in the form of microfiche files or other formats including hard copy records from county courthouses, libraries, and related field offices that house this data. Thus, it is clear that a large number of different governmental institutions may include archives of such data. However, private institutions and individuals may also control access to such data.

The apparatus and the method gain access to energy-related information or documents that need to be processed for efficient information extraction and then compile the data on servers for processing. In one configuration, the process gaining access to energy related information may be retrieved by manually scanning the document or a partial or a full automation of the document scanning process. However, in general, the result of document scanning is to transform the various hardcopies into a computerized format. In general, the initial result of such a scanning process will be an image of the scanned page. Such an image should be a lossy or lossless image that includes information about what is included in the scanned documents. For example, different formats that maybe used include JPEG, IMG, BMP, TIFF, GIF, and so on, though these are merely example image formats and other appropriate formats are used in other examples. Additionally, the images, in various examples, are either monochrome or have varying levels of color depth. Other aspects of such images, such as resolution also may vary, as long as the images include sufficient detail to perform Optical Character Recognition (OCR) on the images. In general, the images include text, as discussed above, which may be handwritten or mechanically printed.

However, some images also include diagrams, such as maps or plot diagrams. In some examples, the images are analyzed to determine which regions include recognizable text, and which regions include line drawings or other graphically significant regions. Additionally, such examples may store such images so that when subsequently analyzing the text, it is possible to associate the images with relevant text.

TextOre offers a proprietary on-line text mining bureau service (“TextOre.net”) which, using key words, phrases, and a set of documents to be analyzed as inputs, produces a visualization matrix showing how often each combination of keywords or phrases are associated in the analyzed set of documents. By performing such analysis, in an example, it becomes possible to track information such as transference of certain mineral rights to determine which areas are most valuable and what issues will arise when acquiring them. It is noteworthy that because this data mining technology is well-adapted to analyzing governmental records to track who holds title to a piece of property, it is potentially applicable to guaranteeing clean title or otherwise resolving who has rights to a contested piece of property.

For example, the data mining apparatus and the method thereof normalize and convert data from scanned image files to digital files using specific image conversion OCR software such as ABBYY Fine Reader. However, this is only one example of relevant OCR software, and other similar software is used in other examples. For example, any OCR software that is able to transform an image file stored in one of the image files discussed above or another appropriate image format is used, where the OCR uses techniques to analyze the bits in the image to guess which character is intended for use in the scanned image. Additional aspects of the OCR process are presented, below.

The conversion process involves turning the microfiche file to JPEG, and then from JPEG to PDF, until finally rendering the file in an HTML format which will be fed into the Information Refinery processor and method and mined for the most relevant data. However, these are only examples of formats used in the conversion process. For example, the microfiche file is potentially stored as a TIFF file, which is converted into a PDF using OCR, or the OCR produces a TXT or HTML file. Overall, the examples are not limited to any specific formats, and what is required is merely that the hardcopy is scanned into an image file, that such an image file is processed using OCR to yield character data, and that the character data is stored in an appropriate textual format. An issue with OCR is that only a certain level of accuracy is potentially attainable. However, OCR technologies are able to achieve accuracy levels of 80% or higher, and recognized text that is of this level of accuracy is generally accurate enough to be useful for analysis and comparison. In order to achieve OCR results with this level of accuracy, it is generally necessary to train the OCR software to improve its recognition capabilities. In examples, such training involves automatic training, such as using a training corpus, or alternatively training involves manual training, where users review the OCR results and correct errors to improve recognition rates. While mechanically printed text is generally consistent and fairly easy to OCR accurately, handwritten text, especially cursive handwritten text is often more difficult to OCR accurately. However, one aspect of certain document collections is that some groups of documents were all written by the same individual, and hence handwriting patterns are consistent over groups of those documents. For example, the county clerk for land deeds in one county's land office was usually employed and operated as a single individual or a small group of individuals, and as a result handwriting is consistent across the set of land deeds in such a land office, making training and accurate recognition easier.

In general, an appropriate textual format will be a text file, such as TXT, including ASCII or Unicode information, or a markup language file such as HTML. However, it is to be appreciated that other markup formats, such as XML or SGML or XHTML are used in other examples, as well as other appropriate document formats such as DOC format, or any other relevant format. Additionally, the information may be stored appropriately in a database, such as a relational database.

An additional consideration with respect to how the information is processed is managing the processing and storage demands of processing the information, which as discussed previously may include hundreds of gigabytes or even multiple terabytes of data. Keeping such factors manageable is accomplished using certain approaches in certain examples. In general, two approaches used to keep processing demands manageable or otherwise distribute the processing are clustering and distributed processing technologies such as Hadoop.

In clustering, the gathered data is analyzed to determine characteristics of the documents, and then gathered into clusters that are used to filter the documents so that a user can limit the documents to be considered in the analysis using filters that eliminate certain documents that are likely to be irrelevant. For example, filters might cause the analysis to be limited to a certain time range, such that only documents from 1980 to the present are considered. As another example, filters might restrict the geographical range of documents to be considered, so that only documents associated with a certain county or set of plots of land are considered. As yet another example, filters might restrict the type of documents, so that only wills and tax documents are considered. In order to perform document clustering, a tool such as Piranha is potentially used to manage and organize the documents.

Piranha is a text mining system developed for the United States Government. Piranha processes many unrelated free-text documents and shows relationships amongst them, and the results are presented in clusters of prioritized relevance to business and government users. Piranha is able to collect, extract, store, index, recommend, categorize, cluster, and visualize documents. The present examples use and expand upon such abilities, provided by Piranha, to help perform initial management of documents in the Information Repository.

Distributed processing technologies such as Hadoop are another way to improve performance and manage the large processing burden. Apache Hadoop is a set of algorithms, presented as Java code that constitutes an open-source framework, that facilitates distributed storage and distributed processing of very large data sets, referred to as Big Data, such as that considered by examples. Hadoop can be implemented on a variety of standard hardware, and stores and processes data blocks in parallel, as well as being extremely fault-tolerant. Hadoop distributes the data using Hadoop Distributed File System (HDFS) and processes the data using a processing distribution approach known as MapReduce. By using Hadoop, processing tasks are divided among hundreds of servers. However, Hadoop is only one example of distributed file storage and data processing that allows Big Data to be processed and stored using a “divide-and-conquer” approach. Hadoop has the advantage of offering the ability to use multiple computers distributed over a network to provide parallel facilities for handling the data in examples, improving reliability through redundancy. Parallel processing also offers the ability to speed up data processing tasks that would otherwise be much slower, potentially even offering real-time data analysis capabilities. Such real-time speeds are often important in the contexts where examples are used, because business opportunities often disappear if a competitor realizes their existence first. Additionally, faster processing avoids user frustration.

Once the information is integrated into a central repository, the analysis is able to take place. Such analysis involves the processing of files using algorithms to search, mine, and detect patterns among key concepts or data elements.

The converted files are then introduced into the Information Refinery processor wherein the converted files are processed to produce desired data. This is aided by the injection of “Key Terms” into a searcher or a search function in the method, which allows the user to quickly sift through large data files and cull only the most important pieces of information. The search function includes entered defined key words, phrases, company names, country names and other relevant search concepts of the client's choice. All selected search terms are to be entered into an input screen in a prescribed manner and predetermined format. In accordance with an illustrative example, a detailed description of the process is as follows.

The input to TextOre is a number of regular expressions. The “scanner” portion of the TextOre proprietary algorithm, as discussed further below, takes these regular expressions, models them into a finite state machine (FSM) and compares them to some unstructured text data. The scanner finds co-occurrences of regular expressions in the text data. If the text data is separated into documents, and the TextOre scanner is configured to recognize document boundaries as part of applying the FSM, the number of regular expression co-occurrences in each document is recorded. If the text data is separated into paragraphs, and the TextOre scanner is configured to recognize paragraph boundaries as part of applying the FSM, the number of regular expression co-occurrences in each paragraph is recorded. Note that recognizing paragraph co-occurrence is extremely valuable and is often an unappreciated advantage over the Google algorithm for searching, as well as other searching approaches.

The basic or initial structure of the visualization is a grid with some keywords, which are potentially regular expressions, across the top as columns and some keywords, which may also be regular expressions, down the side as rows; each cell of this grid represents the intersection or co-occurrence of the two regular expressions in that row and column. Within each cell of this grid is displayed a solid, colored square the size of the square corresponds to how many documents or paragraphs that contain both of that particular pair of keywords, corresponding to the row and column. However, other shapes, such as a rectangle or a circle is used in other examples, with appropriate modifications.

Upon clicking any square in the grid, the user is presented with a list of the documents or paragraphs containing that combination of concepts. The squares of the grid can be configured to be color-coded by row and/or column as a feature that provides visual assistance for the user.

In examples, the input regular expressions used as keywords are optionally grouped into lists that can be thought of as synonyms that form a concept. For example, the regular expressions “comput*”, “electroni*”, and “technol*” can be put into a list representing a “computer technology” concept. As another example, the regular expressions “Obama”, “Washington”, and “U\.?S\.?A” can be put into a list representing an “America” concept for geopolitical analysis. Each list of synonyms, once grouped into a concept, subsequently appear as one row or column of the grid visualization. This ability to process the inputs and outputs as lists and concepts simultaneously is one of the most powerful features of the proprietary TextOre algorithms. The keyword list may include misspelled words deliberately chosen to match erroneous output from an OCR process.

The input concepts, such as lists of regular expressions can further be grouped into larger sets with multiple concepts in each set. This does not necessarily correspond to a particular psycho-linguistic paradigm, but is built into TextOre as a convenience for the user. These sets can correspond to larger concepts such as “noun”, “verb”, “person”, or “place”. In some examples, these sets do not have corresponding names in the TextOre system and the user is free to organize these sets however he or she wishes. The effect on the visualization is simply that the first set defined in the input is used as the concepts across the top of the grid.

Additionally, the user is free to organize the synonyms and concepts however he or she likes, to garner the best value from the visualization according to his or her specific research needs.

Examples, when tested, showed no degradation of performance with up to 900 regular expressions in the input. Because TextOre is meant for human review and interaction, many useful capabilities are available without processing more than 900 regular expressions at a time.

Once the data has been gathered, it is to be mined and interpreted prior to visualization. The mining and interpretation is based on applying concepts and keywords to identify documents which include such concepts and keywords. When documents include such concepts and keywords, they are likely to be relevant to the user. Moreover, the mining and interpretation determine where multiple relevant terms occur together. For example, when considering land documents in the energy space, terms such as “descendancy” and “conveyance” are identified, and further identified when they occur together. For example, concepts and keywords include relevant legal terms, relevant technical terms, and proper nouns naming individuals germane to transference of rights. Thus, based on this information, examples track coordination between multiple relevant terms. Such information may be reported through a visualization, such as a matrix. Such visualizations are discussed further, above and examples of such visualizations are discussed below.

From the user's perspective, examples provide a service to clients to help them manage and interact with repositories, such as databases, that extract and archive information as discussed above. As discussed above, such information is integrated into the system by manual extraction, or by other steps that are automated. Some users just want useful conclusions, and their usage of examples begins after information resources have already been compiled and organized.

An aspect of certain examples is the computerization of management of land office information, which creates a “Virtual Land Office.” Such a “Virtual Land Office” extracts documents, as discussed above, such as deeds, and allows access to the documents by computer. Additionally, the information is optionally stored and managed in one or more servers, and accessed by clients, or is stored and accessed over a network using a peer-to-peer approach. In order to access the information, users also provide information about what information they want, such as by requesting information related to petroleum or mineral rights for a certain county in Texas. In an example, this information is used to generate a “run sheet” which establishes a chain of title. When drilling in a property, it is generally necessary to have an absolutely clean title. By producing a run sheet that organizes all competing titles and their descendancy, examples are helpful in establishing the existence of clean title, so that examples not only identify potentially valuable properties by data mining, but also help establish that it is legal to exploit the properties or mineral assets.

As discussed further below, the examples provide visualizations of the derived data in various forms. For example, matrices illustrated and discussed below present relationships between terms. However, other visualizations are possible, and present information graphically. For example, such visualizations used in examples include landmaps, heatmaps, contour maps, word clouds, peaks and valleys, and so on.

The processing includes three main stages, which are matching, extracting, and generating. Matching is the scanning process that identifies where terms occur. In extracting, the match list is processed to organize conclusions about where keywords co-occur. In generating, the conclusions become an organized visualization. These stages are to be discussed further, below.

In order to determine how to extract information from the corpus of documents, it is first necessary to obtain a set of terms and keywords that are used to process the documents. For example, in the field of land documents related to the energy field, the terms of interest could include legal terms related to conveyance and other aspects of property rights and transference. However, different sets of terms may be used in different contexts. For example, different sets of terms pertain to extracting different types of information, such as discriminating between information related to natural gas and information related to oil. Additionally, different sets of terms may be relevant to different jurisdictions, such as different states or counties if examples are used in the U.S., or other sets of terms may be appropriate for international use. Further, examples may be adapted to recognize certain foreign language terms, such as Latin or Spanish terms, or may be adapted to translate or otherwise process documents in different languages, such as French or Mandarin Chinese.

For example, terms and keywords as discussed above are populated into a list by experts, such as lawyers, scientists, and engineers who are familiar with the field of use of the examples, and can select terms and keywords that are likely to help identify relevant documents. Thus, examples use appropriate pre-populated lists. Additionally, once a pre-populated list is selected, a user potentially expands upon or modifies the list. Also, lists optionally use regular expressions and related approaches such as wildcards to help identify terms and keywords. For example, lists may expand terms and keywords to include synonyms, plurals, and other related words to help improve the ability to identify related concepts. For example, the analysis may look not only for “heir” but also “heirs.”

Part of entering the search parameters also possibly involves other filters, such as a time frame or other restrictions to apply to the documents to be searched, to help keep the number of documents searched to a manageable number.

As discussed, the technologies related to examples have applicability to a variety of fields, such as the energy industry, the title industry, and the health care industry.

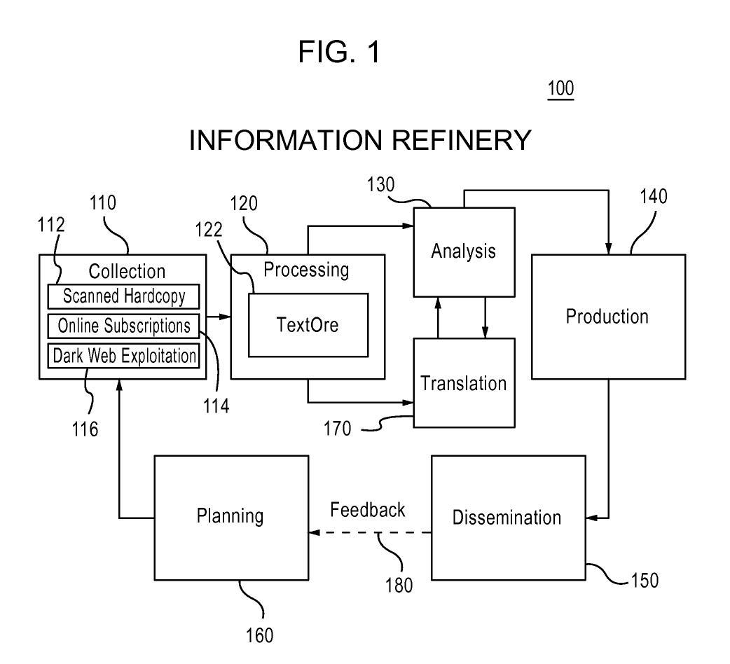

FIG. 1 is a diagram illustrating an example of an Information Refinery apparatus. The Information Refinery apparatus 100 includes a collection unit 110, a processing unit 120, an analysis unit 130, a production unit 140, a dissemination unit 150, a planning unit 160, and a translation unit 170.

The collection unit 110 operates to gather documents, as discussed above, so that they may be accumulated and analyzed. For example, the collection unit 110, as illustrated in FIG. 1, includes scanned hardcopy data 112, online subscriptions data 114, and dark web exploitation data 116. The “dark web” refers to information that is digitally stored, but is not available using standard search engines. For example, information that is stored in databases, but is not considered by standard search engines is considered to be part of the dark web. Additionally, the “dark web” refers to computers that store information, but due to a lack of connection or other hardware barriers, cannot be easily or directly accessed through normal Internet protocols. Using data of these types is important because normally, searching through large amounts of data uses a standard search engine. As discussed, a standard search engine does not have access to all of these types of information, and hence incorporating additional information using these portions of the collection unit 110 is helpful in increasing the range of information accessible to the Information Refinery apparatus 100.

The processing unit 120 processes the information stored in the collection unit 110. Thus, the processing unit 120 includes one or more appropriate processors, as well as relevant memory storage. Within the processing unit 120, the TextOre engine 122 performs text-mining and data analytics in conjunction with the other components of the Information Refinery 100 to search, identify, extract, and mine meaningful information from large amounts of unstructured text.

The analysis unit 130, translation unit 170, and production unit 140, function together to operate on the information processed by the TextOre engine 122 within the processing unit 120. For example, in the example of FIG. 1, the analysis unit 130 analyzes information received from processing unit 120. Additionally, information from the processing unit 120 and the analysis unit 130 is potentially interchanged with a translation unit 170. Here, the translation unit 170 potentially carries out various translation tasks, such as between various data formats or various human languages. Once the analysis unit 130 has analyzed the information, it is operated upon by a production unit 140 that organizes the analysis results into a format suitable for review by a user. Once the analysis results are prepared, they are provided to the user for use as a visualization by a dissemination unit 150. For example, the dissemination unit 150 operates to provide information about the visualization from the TextOre engine 122 via the analysis unit 130 and the production unit 140.

Once the dissemination unit 150 has disseminated the results, the user provides feedback 180 to a planning unit 160. Here, the planning unit 160 incorporates the feedback 180 into a set of key terms and concepts that are used by the processing unit 120 and more specifically by the TextOre engine 122 to process the information stored by the collection unit.

Therefore, the Information Refinery apparatus 100 operates based on a feedback mechanism where a repository of information is processed to yield results representing aspects of the information, the results are organized and presented to a user, and the user is able to use the results to provide feedback that governs further analysis and manipulation of the information to yield useful results and conclusions.

Applicants have presented FIG. 1 as an example of the structure of an Information Refinery apparatus 100. However, it is to be noted that this is merely a general example of how an Information Refinery 100 and also other examples include appropriate modifications to the Information Refinery 100 that accomplish similar tasks using slightly different approaches. For example, the processing unit 120 uses various processor types and configurations in various examples, or the collection unit 110 uses different storage technologies to store the information.

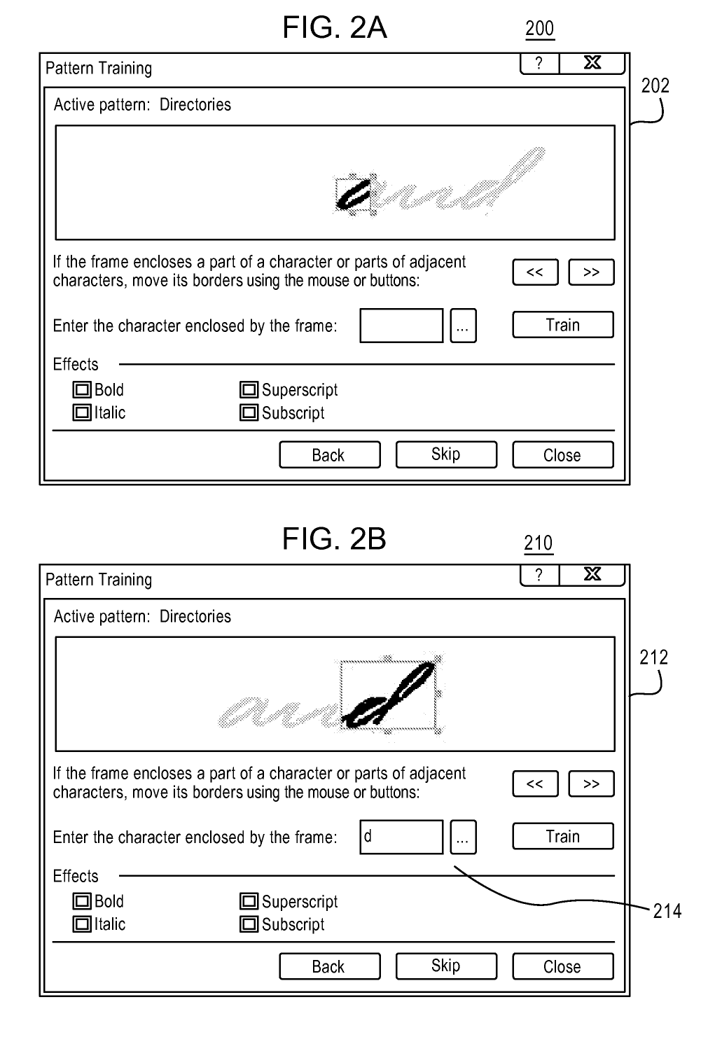

FIGS. 2A-2B are screenshots 200 and 210 illustrating examples of handwriting recognition. As discussed above, in order to integrate scanned hardcopy documents 112 into the collection unit 110, it is necessary to perform Optical Character Recognition (OCR). Optical character recognition (OCR) is the mechanical or electronic conversion of images of typewritten or printed text into machine-encoded text. It is widely used as a form of data entry from printed paper data records, whether passport documents, invoices, bank statements, computerized receipts, business cards, mail, printouts of static-data, or any suitable documentation. It is a common method of digitizing printed texts so that it can be electronically edited, searched, stored more compactly, displayed on-line, and used in machine processes such as data mining. Various techniques of OCR are used to integrate information into the collection unit, depending on the information to be integrated. However, FIGS. 2A-2B illustrate a particular OCR technique that is particularly helpful in the context of examples. FIG. 2A illustrates a pattern training dialog box 200 and FIG. 2B illustrates a pattern training dialog box 210. These dialog boxes each illustrate a handwritten version of the word “and” for recognition. In pattern training dialog box 200, in word box 202, part of the character “a” has been surrounded by a frame. However, in word box 212, the entire character “d” has been surrounded by a frame, and in pattern training dialog box 210, the contents of the frame have been associated with the character d at box 214. Hence, FIGS. 2A-2B illustrate an OCR technique that is particularly helpful for recognizing handwritten text, where a user places a frame around a handwritten character and trains the OCR engine to recognize characters in a specific way.

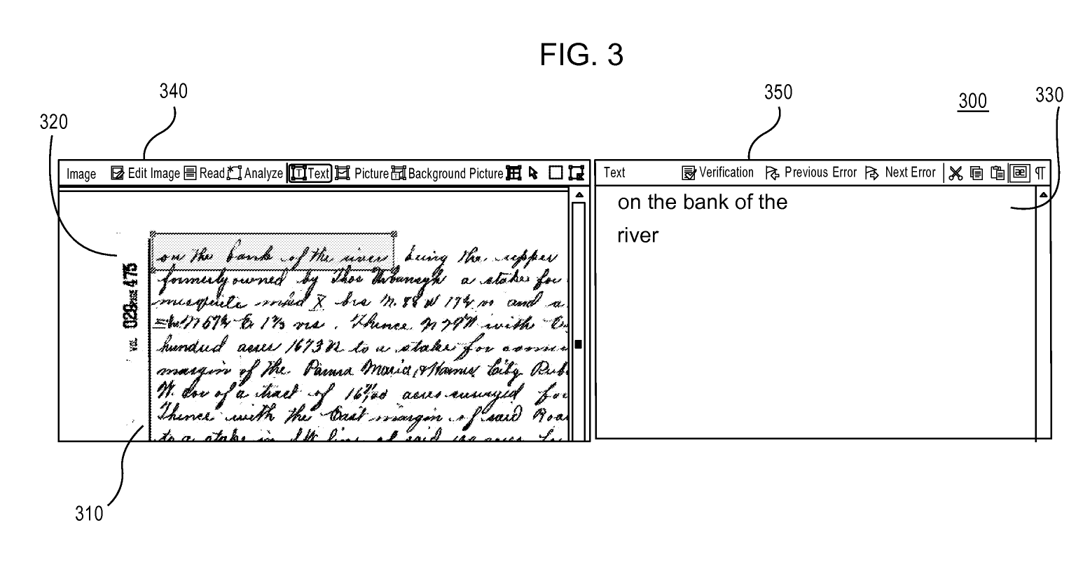

FIG. 3 is another screenshot 300 illustrating an example of handwriting recognition. In FIG. 3, area 310 is an image of a scanned, handwritten document. Frame 320 surrounds a portion of the handwritten text of the document. In window 330, the portion of the handwritten text surrounded by frame 320 has been recognized as “on the bank of the river”. FIG. 3 also illustrates an example for handwriting recognition that provides image controls 340 and text controls 350. In the example of FIG. 3, image controls 340 include controls to edit an image, read the image, analyze the image, mark text, mark a background picture, and so on. In the example of FIG. 3, text controls 350 include controls for verification, such as controls that allow a user to manage and identify errors in the OCR results. While window 330 shows text that has been recognized successfully, manual correction or automated correction is used in certain examples to improve the accuracy of the OCR results.

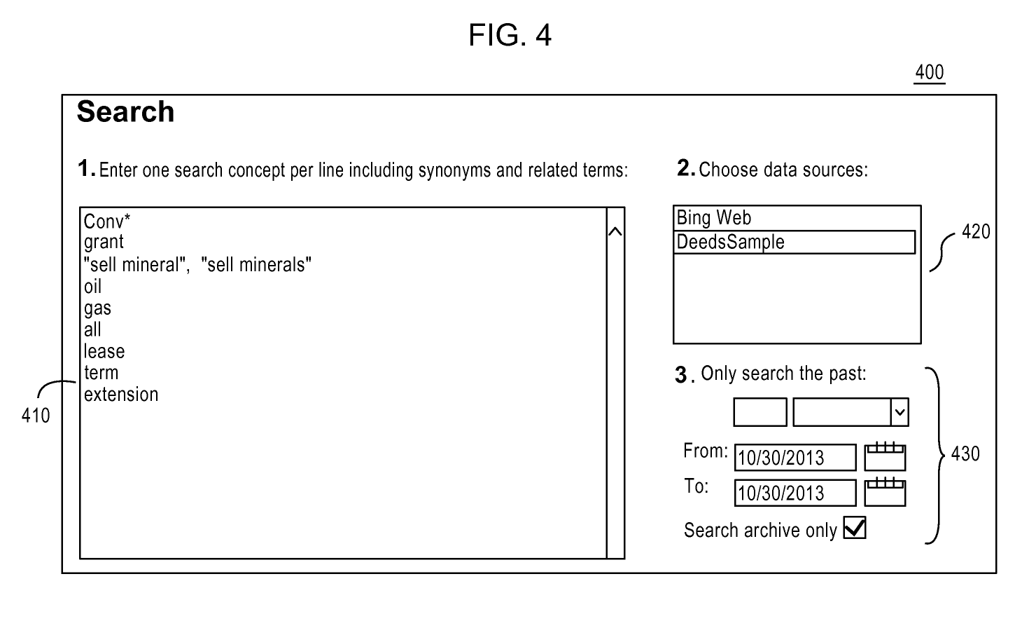

FIG. 4 is a set of screenshots illustrating an example of entry of key terms. The search window 400 includes a search concepts window 410, a data sources control box 420, and a time range control box 430. By providing inputs into the search window 400, the user is able to guide how the Information Refinery apparatus 100 processes information.

With respect to the search concepts window 410, FIG. 4 shows examples of search terms, each entered on a separate line. FIG. 4 also shows that search terms may be entered as single, explicit terms, such as “oil” and “gas”. However, search terms are entered in other examples as regular expressions, such as “Conv*” that use wildcards to provide flexibility. Additionally, it is possible to enter multiple, related terms together, such as “sell mineral” and “sell minerals” where the terms are similar, but are presented as plurals, or as different conjugations of a verb.

With respect to the data sources control box 420, FIG. 4 shows examples of selecting a data sources database. FIG. 4 shows “Bing Web” and “DeedsSample,” of which “DeedsSample” is selected. In general, at least one data source is chosen as an origin of information to search through. However, in other examples, multiple data sources are chosen, or the user restricts which portions of a data source are considered. Of the presented examples, “Bing Web” is taken to represent results obtained by doing a preliminary web search with the search engine Bing, while “DeedsSample” is taken to represent a database of land deeds compiled from a variety of sources not present in the indexed Web, such as the sources discussed with reference to the collection unit 110.

When determining a data source, using a web search engine such as Bing Search, or an alternative web search engine such as Google Search or Yahoo, the advantages of using a web search engine are that such a data source is quick, provides a certain amount of relevancy, and the information retrieved is generally already in an easily processed format, such as HTML or XHTML. However, these sources are usually limited to web pages, and only have access to data that is indexed by a given search engine. Also, such search engines are not necessarily well-adapted to processing information with high levels of granularity. Hence, using a data source such as “DeedsSample” that includes data sources with a wide variety of origins and granularity that goes beyond that of a search engine are used.

With respect to the time range control box 430, the user uses various graphical controls to restrict the time range of documents considered. For example, FIG. 4 illustrates an example where documents from Oct. 30, 2013 and Oct. 31, 2013 are considered. FIG. 4 also illustrates an example of a checkbox, “Search archive only” which is an example of specifying parameters to use when filtering data from a data source.

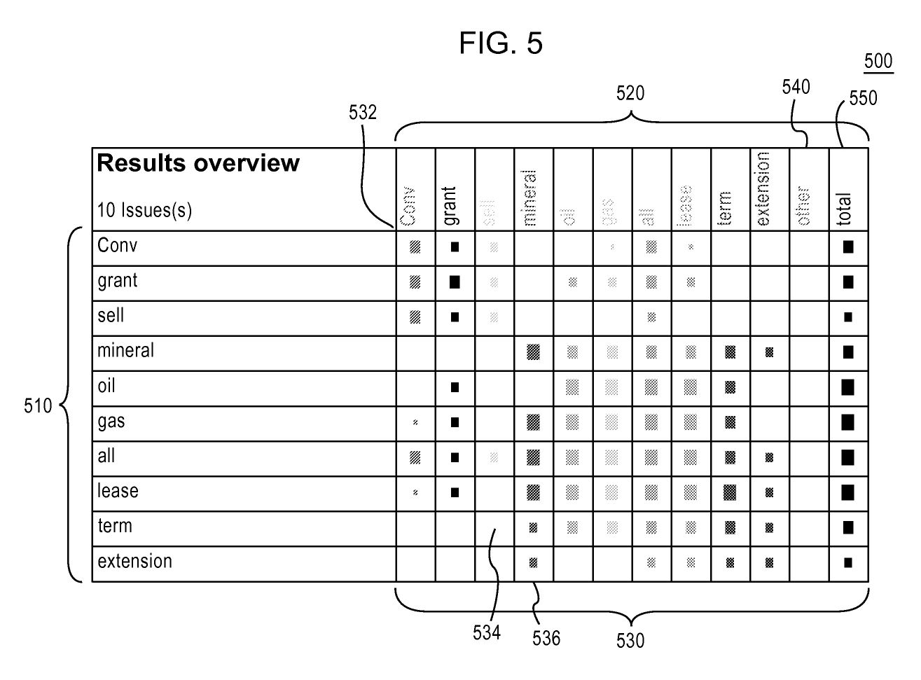

FIG. 5 is a screenshot illustrating a results overview 500. FIG. 5 is only one example of many possible results overviews and visualizations, and various variations on the results overview presented in FIG. 5 are possible. Additionally, various other example variations of possible overviews and visualizations are considered, below. The results overview 500 presents a matrix or table where each of the rows 510 is associated with a search term, each of the columns 520 is associated with a search term, and each position in the matrix itself includes a visual indicator that informs the user how often the search terms corresponding to the row and column that intersect at that matrix position co-occur in a paragraph. While the example of FIG. 5 illustrates the use of a colored rectangle, other examples use other ways to indicate how frequently search terms coincide. For example, shapes, symbols, three-dimensional shapes, brightness or grayscale levels are used in certain examples to illustrate how often terms coincide in the data sources selected. For example, the symbol at 532 is chosen to have a size and color that are indicative of the co-occurrence in documents of terms corresponding to the “Conv” search term. As a further example, the lack of a symbol at 534 indicates that there is no co-occurrence between the terms “extension” and “sell” while the small rectangle at 536 indicates that there is some co-occurrence between the terms “extension” and “mineral”. Additionally, the example of FIG. 5 includes columns 540 and 550, where column 540 is an example of a column that is optionally used to analyze co-occurrence between terms and other terms. Additionally, column 550 indicates a total level of co-occurrence, and hence provides a visual representation of the overall co-occurrence between a search term and the entire set of terms.

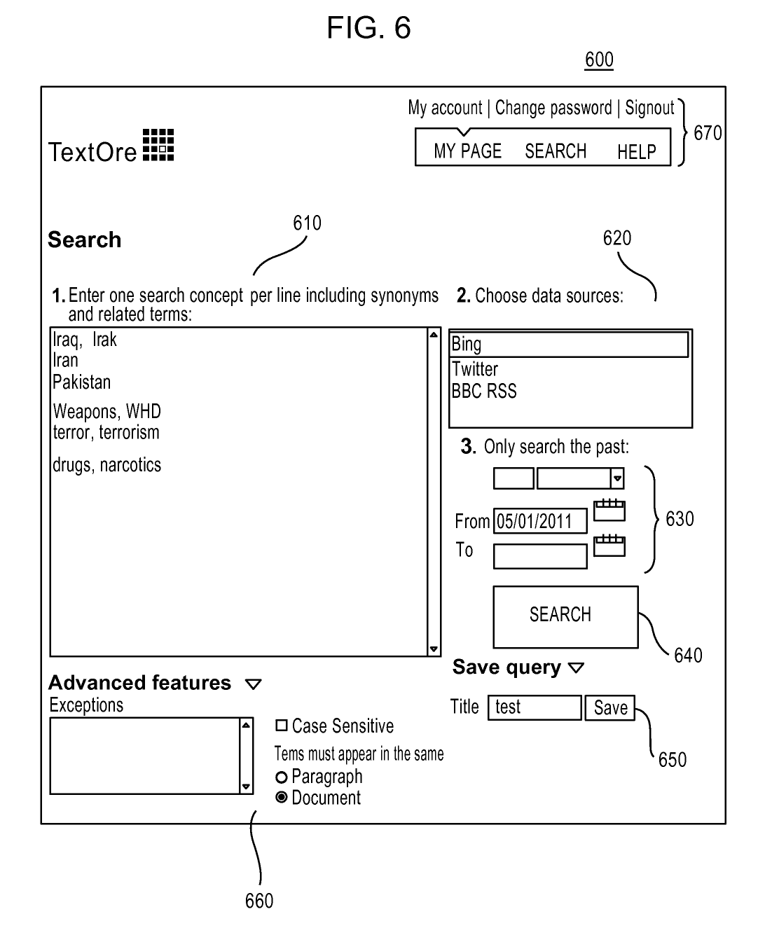

FIG. 6 is a screenshot illustrating an example of an Input Stage for key terms. The input stage begins with the user. The user inputs the search criteria, such as key words, phrases, company names, country names or other relevant terms, which are used to define what TextOre will look for during the “mining” process. The first input field is the “keywords” field. Here, the user inputs the actual search criteria. Unlike traditional Boolean searches which are usually effective with a limit of four or five terms, TextOre is capable of analyzing text using multiple categories and multiple terms and synonyms within each category simultaneously. In examples, the resulting profile has two or three categories with a few concepts in each category, or the profile is much more elaborate, with twenty or more categories with forty or more concepts and synonyms within each category.

The “exceptions” field allows elimination of specific terms from the search which may appear in the “key words” field, but which in their context have no relevance to the specific search. In an example, not shown, a user searches the telecommunications field, but chooses to exclude “fuel cell”, “interest rates”, “phoned”, “phone interview”, “by phone”, “by telephone”. Through experience in research, telecommunications searches may include these terms, but exclusions help to eliminate results that are not relevant to the telecommunications search being currently performed.

The “data source” field is the repository of data for TextOre to “mine”. This is where the user places all the text sources that TextOre is going to search from. These sources can include any resources from the Web or any other newswires, newspapers or articles. Also with TextOre's ability to “mine” in multiple languages, in some examples keywords are input in foreign languages and TextOre also mines against foreign sources.

Once the user has completed the input stage, he or she selects “Search” and then TextOre processes the data to yield the results.

With more specific reference to parts of FIG. 6, the search window 600 includes certain similar features to those presented in FIG. 4. For example, search concepts window 610 also includes examples of keywords used as search terms. However, search concepts window 610 illustrates different examples of presenting and considering related terms. For example, search concepts window 610 includes “Iraq” and “Irak” together, which illustrates the use of words that are spelled differently but refer to the same concept or sound the same. Another related example is “Weapons” and “WMD” which shows the use of acronyms. The search window 600 also includes a data sources control box 620 that is similar to data sources control box 420 and a time range control box 630 that is similar to time range control box 430. The search window 600 also includes a search button 640, which when selected causes a search to occur. The search window also includes query management controls 650 that allow a user to enter a name for a set of terms used for a query and save the query for future use. Finally, advanced features controls 660 allows the use of additional information to further improve the quality of returned results, such as by specifying terms to exclude as exceptions, a setting that defines if the terms are case sensitive, and an option that indicates whether the terms are to be found together in the same paragraph or the same document.

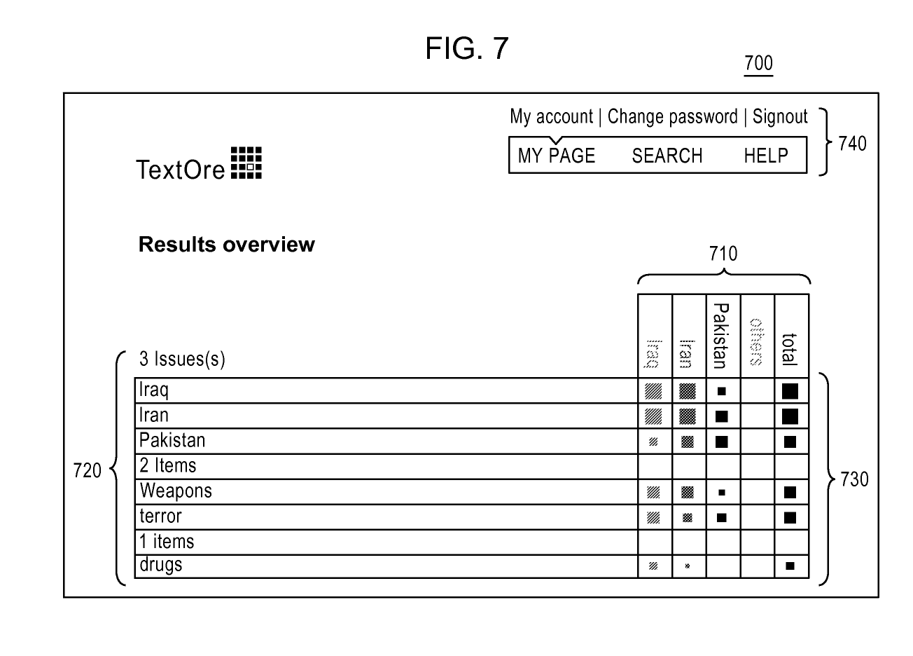

FIG. 7 is a screenshot illustrating an example of First Level Analysis. Once TextOre has mined the text data, it takes all of the processed information and opens with a visualization chart 700 as seen in the example of FIG. 7.

The visualization chart 700 includes three simple-to-explain and easy-to-use sections. These include the top columns 710, the side rows 720, and the chart blocks 730.

The top columns 710 are the key concepts of the search criteria. Every term listed down the left side is mined against these terms. These terms are also listed in the top section of the left side for comparison against each other. The two far right columns, “other” and “total”, are also useful. The “other” column shows where a term listed on the left appeared in conjunction with any other term listed in the left column except those already matched with the top. The “other” column allows a user to grab and utilize information the user was not initially looking for but has subsequently found vital to the search. The “total” column shows all of the hits for a particular term regardless of its relationship.

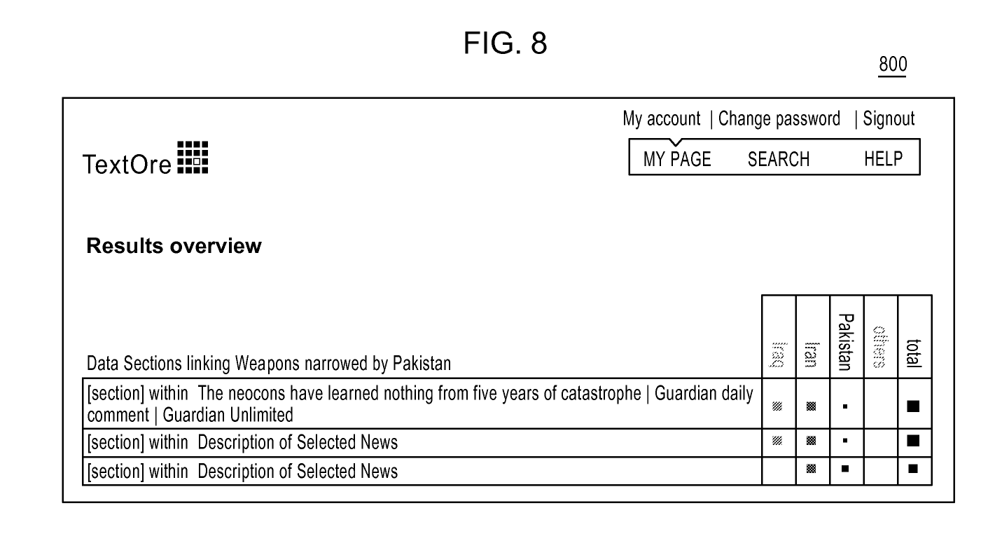

The side rows 720 are the terms used to narrow and define the actual results to define a corresponding relationship with the key concepts. These terms are also optionally viewed in a three way set of relationships simply by clicking on the term in the left column. Thus, the user selects a match to get all of the documents within that cross-term search. This feature allows cross matching analysis to be performed on two and three terms simultaneously to refine the information being searched to identify a small number of key matches. This concept is explained further with respect to Second Level Analysis at FIG. 8.

Within the visualization chart 700, there are chart blocks 730. Each block is color coded to match each individual key concept across the top. Also, the size of the block represents how many times a relationship occurred between two terms, where the larger the block size, the higher the frequency of hits. This allows a user to instantly see where there is a lot of information between two topics and also where there is a lack of information between two topics. When the cursor is placed over an individual block, a user is notified exactly how many hits occurred between the two terms. By clicking on the blocks, the user is able to select links in order to narrow or search each individual section of the documents containing the relationship the user is specifically looking for.

FIG. 8 is a screenshot illustrating an example of Second Level Analysis.

Since TextOre's mining process allows a user to see a correlation between terms, the Second Level Analysis level provides added value. This level is where a user can view a relationship between two terms and drill or link directly to the section within the article or document which the user is looking for.

As the analysis chart 800 illustrates, each hit is presented as a row that includes the title of the article, if available, and the source from where it came. Also, a user still has the ability of comparing the term he or she selected to any of the keywords that he or she initially chose in the beginning.

Once the analysis chart 800 is displayed, in an example, the user chooses to view the section of the article in which the correlation took place without having to read the entire article. For example, the user is able to link directly to the section of interest. The benefit of this capability is time. Here, the user views only the section he or she needs or has interest in without having to find it by reading the entire article. However, if the entire article requires consideration then the user is also able to easily select the article and read it in full-text format.

Additionally, although not illustrated, when drilling down using a term to gain a three level comparison, as discussed, the user again sees a chart similar to that shown in the first level analysis but shows only the comparisons between the top and left side terms as they relate to the selected term. This allows for total control of finding exactly what the user is looking for very quickly.

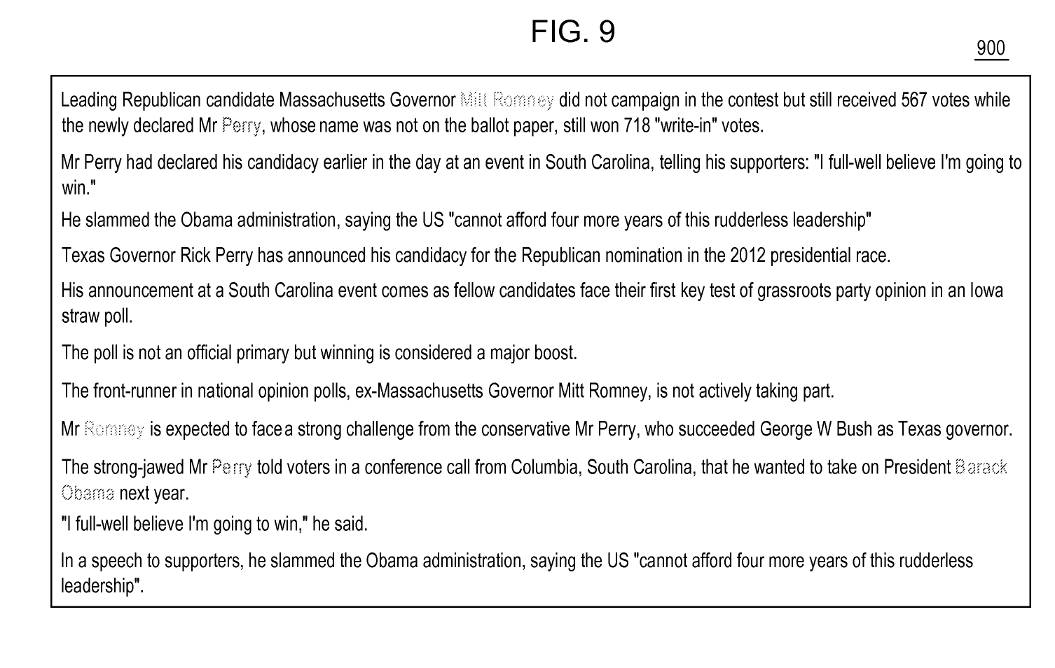

FIG. 9 is a screenshot illustrating an example of Text Extraction.

One of the consequences of TextOre's mining capabilities is its ability to not only discover the terms the user is searching for and present them in an orderly, easy to understand fashion, but to extract the terms within the article and present them.

This gives the user the ability to drill down to the very word he or she is searching for quickly and easily. In the example of FIG. 9, TextOre has identified and loaded a relevant article. However, within the article, the keywords are color-coded using the same coloration scheme used in the grid. As a result, it is easy to find each occurrence of the keyword “Perry” because it is displayed in red, and hence is easy to see. In other examples, other ways of highlighting keywords, such as a background color or different font, are also used.

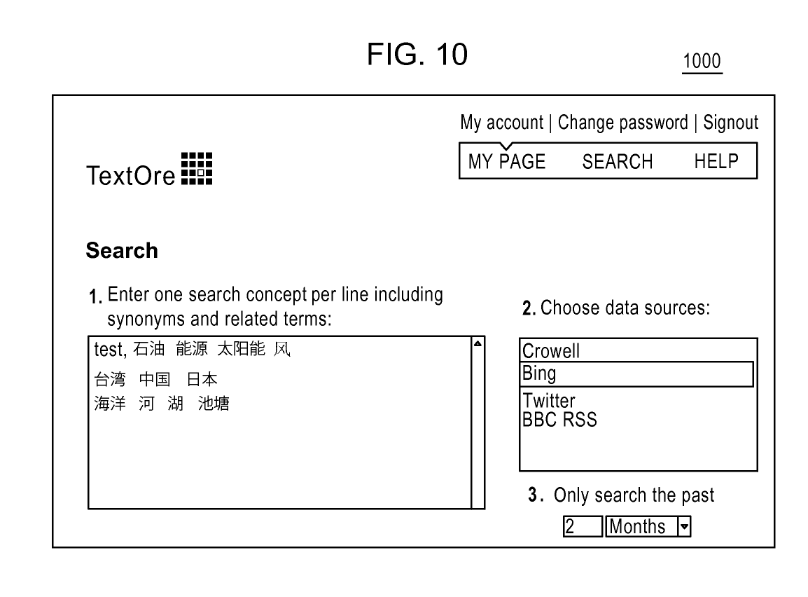

FIG. 10 is a screenshot illustrating an example of use of multilingual key terms. As illustrated in FIG. 10, TextOre's mining capabilities are not limited to the English language. Arabic, Chinese, Japanese, French, Spanish, Russian and Thai are only examples of the languages that TextOre is capable of mining. The multilingual capabilities of TextOre allow users to go worldwide and retrieve information from a wide pool of resources.

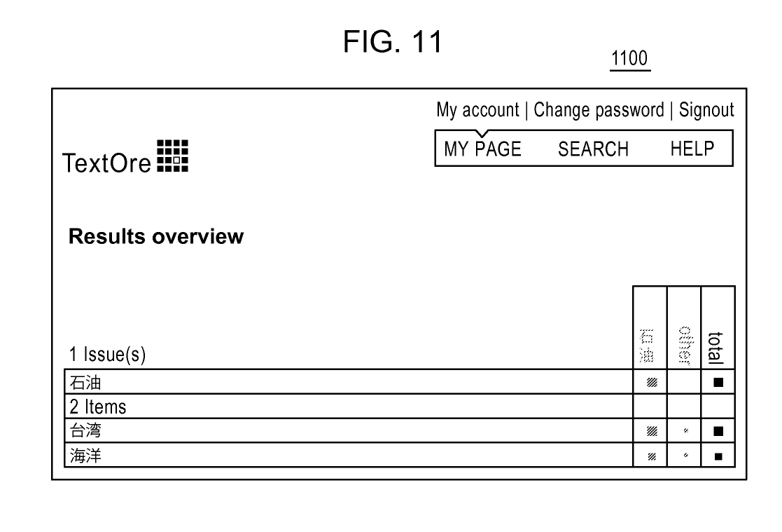

FIG. 11 is a screenshot illustrating an example of use of multilingual key terms in a results overview. The features and structures of FIG. 11 correspond to those of FIG. 7, but the search terms included are presented in a different language other than English, in this case, Mandarin Chinese.

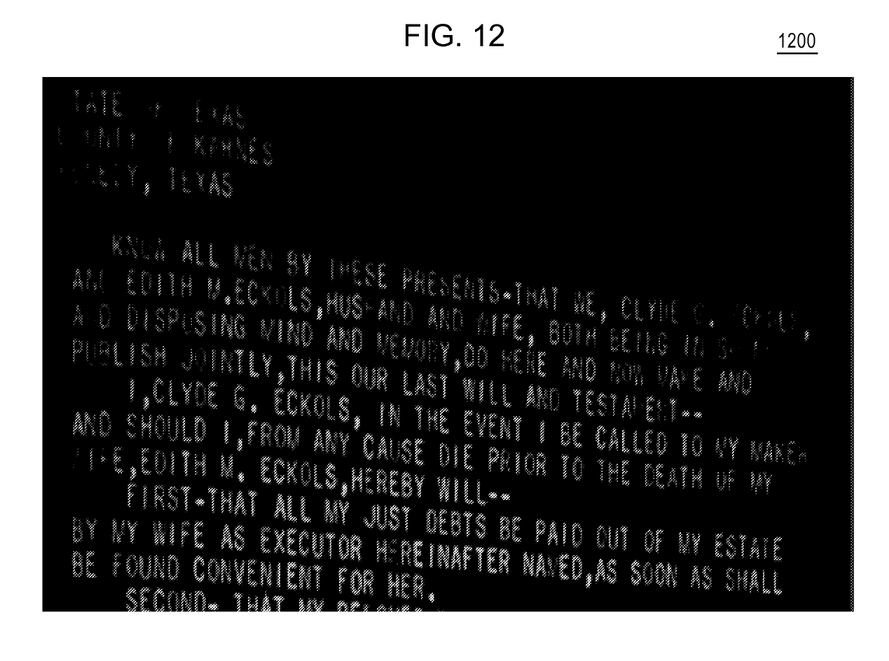

FIG. 12 is a screenshot illustrating an example of a scanned document. The scanned document is presented as an image that corresponds to a microfiche of a will from Karnes County, Texas. This image shows white text on a black background. While the image is not tied in the screenshot to a particular format, various image formats are used to store the scanned version of the microfiche, as discussed above.

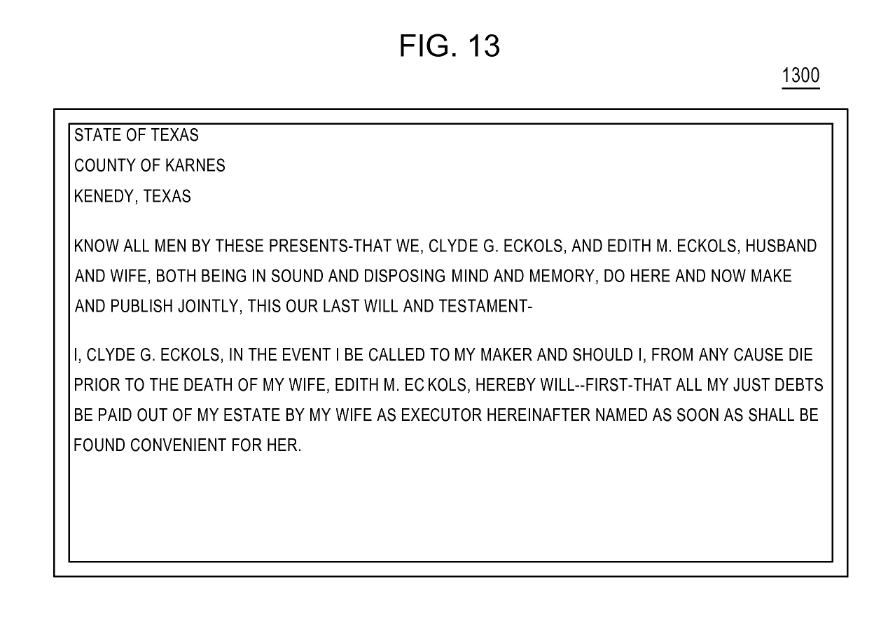

FIG. 13 is a screenshot illustrating an example of a normalized version of the scanned document of FIG. 12. The normalization process has been discussed further, above. As normalized, the scanned document of FIG. 12 has been converted into text, which has been processed for accuracy.

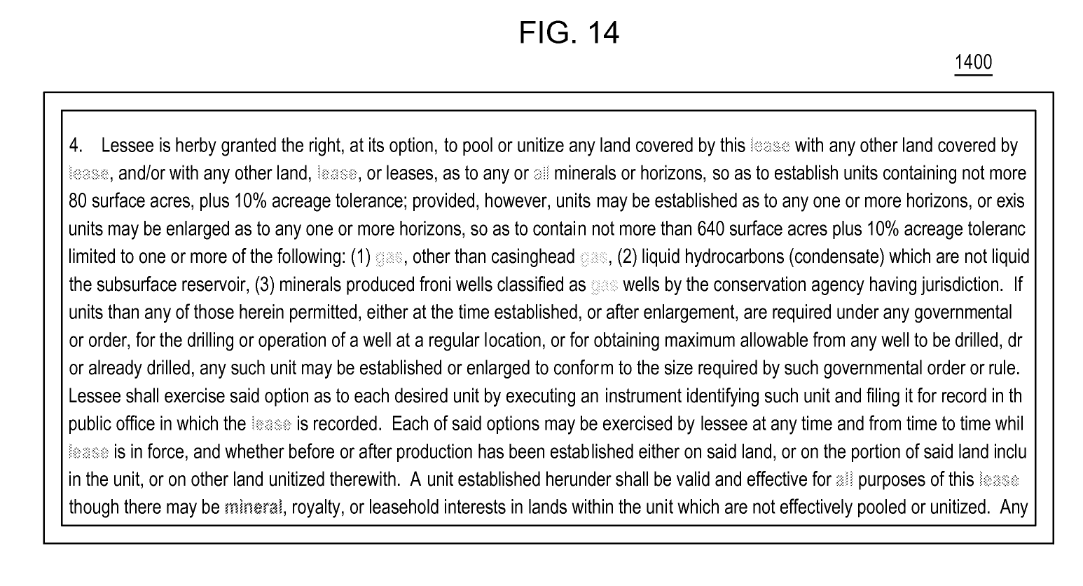

FIG. 14 is a screenshot illustrating a document with highlighted key terms. In examples, key terms may be highlighted in a different color for each term. A related example was presented as FIG. 9. However, other visual means are used to help organize the located terms in other examples. For example, terms may also be highlighted using different background colors or patterns, different fonts, different sizes, different styles, and so on. Additionally, the coloring or other formats associated with different search terms are controlled by the user in various examples. For example, FIG. 14 presents a paragraph where “lease” is presented in a yellowish color while “all” is presented in lavender. Terms not searched for are presented as black text in this example.

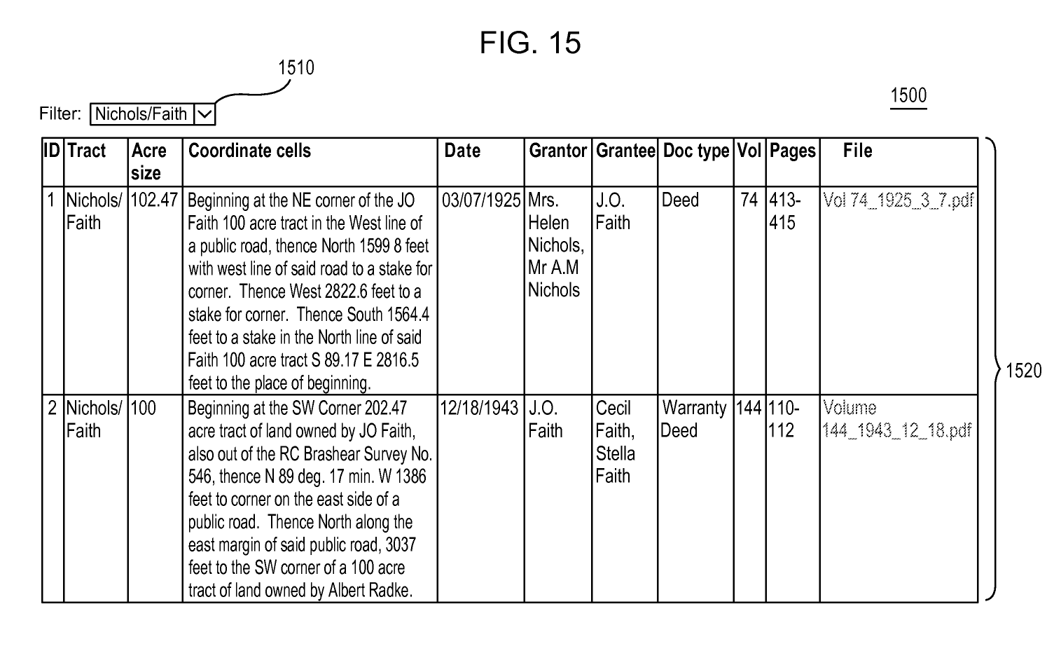

FIG. 15 is a screenshot illustrating results in data table format. Data table 1500 organizes the results of the data mining into a table for further consideration and analysis. Filter box 1510 allows the user to provide a filter, such as the tract name they would like to consider. In the example of FIG. 15, the user has selected the “Nichols/Faith” tract and relevant results are displayed in results table 1510. Thus, the data mining apparatus and method assemble a data table with documents which the data mining has identified as being relevant to that tract, based on the search terms. For example, in FIG. 15 results table 1510 includes columns devoted to a numerical ID for each document, a tract name for each tract, an acre size value for each tract, a coordinate calls value including information about the boundaries of the tract, a date for the document, a grantor, a grantee, a document type, a volume, a set of pages, and a file column with a link that allows the user to access the relevant documents. In the example of FIG. 15, the links provided in the file column allow the user to access PDF versions of the original documents, as stored in the apparatus. However, it is also possible that the original documents are stored in other formats, such as some type of image format or a text-based format that is the result of OCR. In some examples, the original images also include graphics omitted from the OCRed version, such as maps or plot diagrams that are germane to the consideration of the property, but are not appropriate for use in the data mining.

Once unique characters are recognized by the OCR software, the apparatus and method extract full text deeds, leases, medical documents, insurance documents, real estate title-related information, and any other textual information at the sentence, paragraph, and document level:

This manageable and readable text is then converted to an html file and ingested into TextOre's Information Refinery and mined for key words and phrases.

The converted files are then introduced into the Information Refinery method wherein the method and apparatus interact with processes to hone in on desired data. As discussed, this process is aided by the injection of keywords into a search function of the method and apparatus which then uses the processes to identify the specific occurrence of keywords and their possible intersections with other defined keywords in the document thus allowing the user to quickly sift through large data files and cull only the most important pieces of information. In examples, the search function includes entered defined key words, regular expressions, phrases, company names, country names and other relevant search concepts of the user's choice. All selected search terms are to be entered into a search input screen in the prescribed manner and a predetermined format.

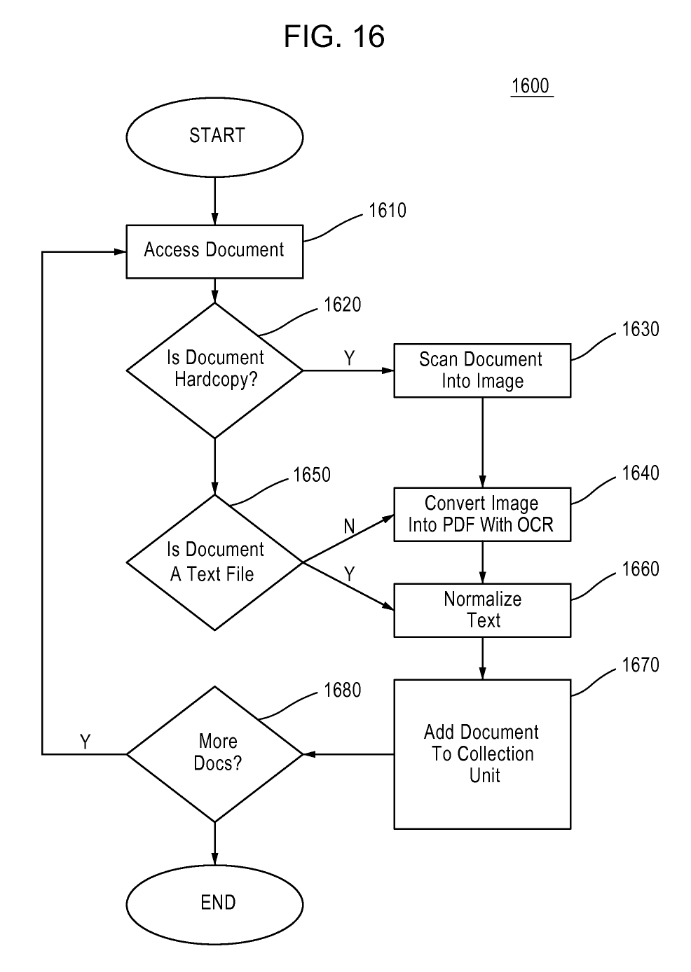

FIG. 16 is a flowchart 1600 illustrating a method of gathering and normalizing information for data mining. In operation 1610, the method accesses a document. As discussed above, the documents originate from many sources, ranging from hardcopy documents such as paper documents or microfiche, or various computerized documents in various formats. In operation 1620, the method determines if the document under consideration is a hardcopy document. In response to the document being a hardcopy document, in operation 1630 the method scans the document into an image file. As discussed above, many appropriate image formats are possibly used to store the scanned document image file. If the document was originally a computerized file, at operation 1650 the method determines if the documents under consideration is a text file. If not, or if the image was scanned at operation 1630, at operation 1640 the method converts the image into a PDF format using OCR, such as by using ABBY Fine Reader. However, this is only one example, and other OCR technology and other formats are used in other examples.

Once the document has been processed to yield some kind of textual representation, at operation 1660 the method normalizes the text. The normalization, as discussed above, includes various operations to ensure that the text is ready for mining. For example, normalization includes processing such as error correction, translation, and reformatting to make it as easy as possible to process the data by using a consistent means of representing the data. After normalization, at operation 1670, the method adds the document to the collection unit. For example, if the collection unit is implemented as a database, the method adds the document to the collection unit so that the collection unit can process the information in the document.

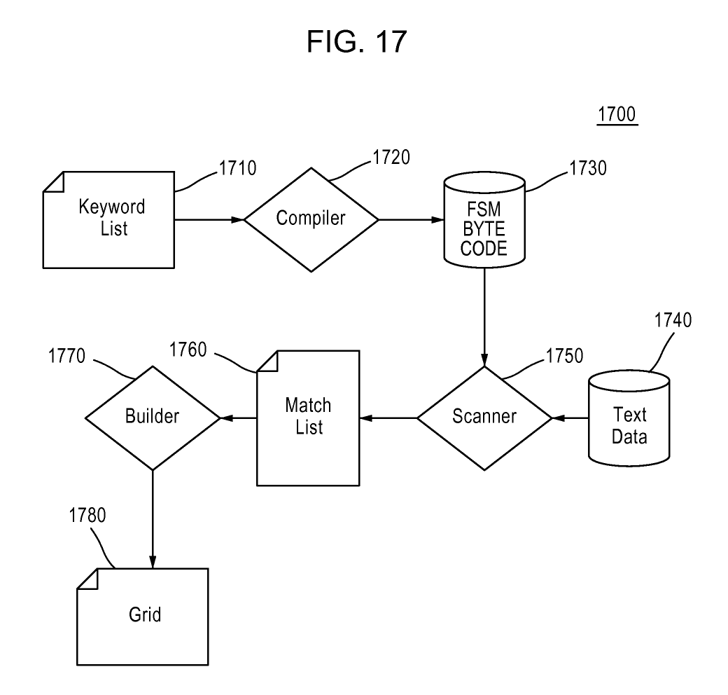

FIG. 17 is a diagram 1700 illustrating elements that perform a method of data mining of information gathered using the method of FIG. 16. In FIG. 17, a keyword list 1710 is provided as input to a compiler 1720. The compiler 1720 compiles the keyword list 1710 into finite state machine (FSM) bytecode 1730. The FSM bytecode 1730 is used by a scanner 1750 to construct a FSM that is used to process the text data 1740 that was previously integrated into the collection 110. The scanner 1750 processes the text data 1740 to produce a match list 1760. The match list 1760 is subsequently processed by a builder 1770 to yield a grid 1780 that provides interactive capabilities, as discussed above. The components illustrated in FIG. 17 are now discussed further.

The keyword list is illustrated by example at FIGS. 4 and 6. In general, keyword lists are not stored by TextOre core software. The user has complete control over the content, as discussed above. The user is allowed to enter, such as by performing a copy/paste operation, the keyword list into the web-based interface each time a query is run. However, in an example, the web-based interface has a built-in memory of the most-recent keyword list query that was executed from each client computer, by IP address. Also, a network implementation optionally includes user account wrappers that allow the user to store keyword lists as named repeatable standing queries. For example, various file management techniques allow TextOre to store and manage keyword lists to facilitate entry of the keyword lists.

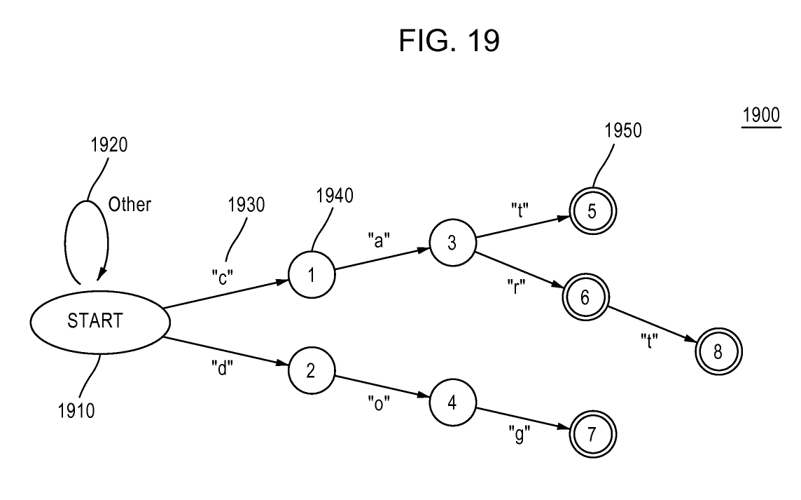

The compiler 1720 processes the keyword list 1710 so as to produce the FSM bytecode 1730. An example FSM is presented at FIG. 19, but in general, the FSM is a mathematical model of computation used to process the corpus to determine co-occurrences. Such an FSM is an abstract machine represented in a technological context that can be in one of a finite number of states, where the machine is in a single state at a time, referred to as the current state. The FSM changes from one state to another based on a succession of events, which are referred to as transitions. An FSM is defined by a list of states and the events that cause each transition. FSMs are useful because they allow a computer to determine a sequence of actions.

The FSM bytecode 1730 consists of two parts. In an example, one part consists of two arrays of integers that represent the states and transitions of the FSM. The two array approach is one existing method of representing a FSM. However, other approaches exist to represent a FSM, and appropriate other representations of FSMs are used in other examples. The second part of the FSM bytecode is a list of the “end” states of the FSM and what they mean to the TextOre system.

The scanner 1750 receives two inputs, including the FSM bytecode 1730 and the text data 1740. The scanner reads the FSM bytecode 1730 and creates data structures in memory corresponding to the provided FSM bytecode 1730. The scanner 1750 reads the text data character-by-character and each text data character guides the traversal of the FSM. Given a current state of the FSM, each character causes the machine to change to another state, where each state is associated with a character. Some states of the FSM are end states that indicate a special event. One such end event is that an entire keyword has just been scanned, at which point the information that the keyword has been identified is output to the match list. Another such event is that a paragraph boundary has just been scanned, at which point a new paragraph label is output to the match list. Another such event is that a document boundary has just been scanned, at which point a new document label is output to the match list. The scanner also keeps track of a count of all characters scanned, so that the position of each keyword within the document/paragraph is also output to the match list when the presence of the keyword is detected, as above. The scanner just establishes a list of keyword locations within the text data, such that co-occurrences are determined later by the builder process. However, the scanner only requires a single pass to process the text data 1740, because the FSM is constructed and traversed such that as the characters are processed, any and all occurrences are identified as the traversal progresses, and hence subsequent traversals are not necessary. The structure and traversal of an FSM is discussed further below with respect to FIG. 19.

The scanner 1750 operates based on the following pseudocode #1:

Pseudocode #1

```
state = START
repeat until end of input:
    read next character of input
    using current state and character input, look up next
state
    state = next state
    is state a special “end” state?
        if so, output match info
```

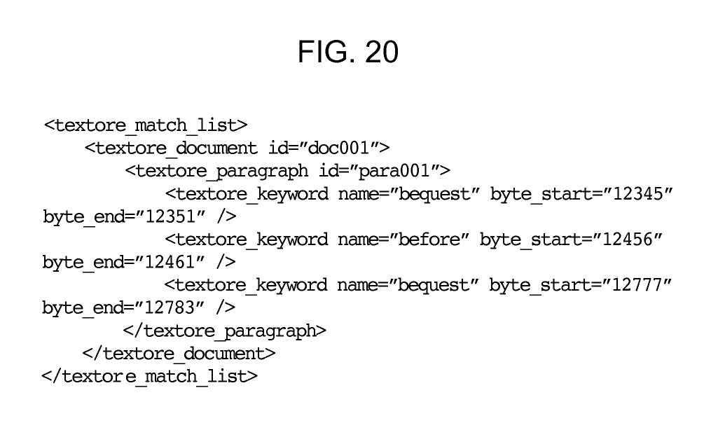

As a result of operating in this manner, the scanner 1750 is able to scan the text data 1740 and produce the complete match list 1760 while only performing one pass through the text data 1740. In an example, the match list is stored as plain text including information about the matches. In other examples, the match list is stored in XML format; in JSON format; or in a relational database. The match list is a nested (hierarchical) list with Documents at the outermost layer, Paragraphs inside each Document, and Words within each Paragraph. Along with each Word is stored the byte offset (file position) of where that Word appears in the Document. An example of a match list is discussed further below with respect to FIG. 20.

The builder 1770 transforms the hierarchical match list into a “flat” list of paragraph IDs along with which words were found in that paragraph (so actually a “list of lists”). In this way, the list of keyword occurrences is transformed into a list of keyword co-occurrences by paragraph. Additionally this list stores the byte offset of each Word found in each Paragraph. In an example, this list is cached in the session for use in the analysis process.

The builder 1770 operates based on the following pseudocode #2:

Pseudocode #2

```
    create an empty list of paragraph info
    repeat for each line of the match list:
        if the line says “begin document”, all following info
    is associated with a new document
        if the line says “begin paragraph”, all following info
    is associated with a new paragraph
        if the line says “keyword”, add this keyword to the
    current paragraph
    if the line says “end paragraph”, add this paragraph to the
list
```

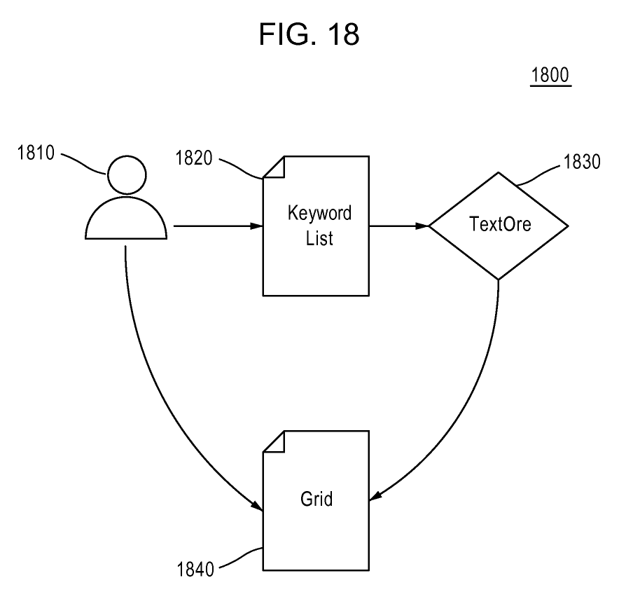

FIG. 18 is a diagram illustrating elements that perform a method of presenting and analyzing information derived using the method of FIG. 16.

In FIG. 18, a user 1810 provides a keyword list 1820. TextOre 1830 processes the keyword list 1820. By performing this processing, TextOre 1830 derives a grid 1840 of results, where the grid 1840 is presented to the user 1810 who may subsequently interface with the grid 1840 to understand aspects of the data being mined.

Thus, the process uses the input of keywords, such as regular expressions, into the input apparatus of the TextOre software, such that a fielded input box appears on the user's computer screen and queries the user to input regular expressions or “concepts” the user wishes to match or find in correlation with other regular expressions or terms entered into the same fielded box.

The process then determines which regular expressions or concepts directly correspond to other regular expressions or concepts as entered by the user in the fielded box or input apparatus.

The process then determines the location of each of the entered regular expressions in the same sentence, paragraph, or document from within a corpus of documents or data. The process then identifies relationships or “matches” between or among two or more regular expressions or terms located in the same proximity within a document at the sentence, paragraph, or document level.

As each relationship or “match” between two or more regular expressions is identified, the process compiles the correlating intersection of two or more regular expressions or concepts into a visualization apparatus or matrix to display all possible combinations or intersections of the terms or regular expressions and to represent the number of possible hits or matches as displayed in a colored box in the matrix visualization apparatus.

As each intersection or match between two or more regular expressions is identified and compiled into the visualization apparatus, the process also compiles all other possible intersections or matches, as entered by the user as additional input of regular expressions, into a large “master” matrix or visualization apparatus of multiple concepts and regular expressions.

This compilation of regular expressions or concepts in the matrix or visualization apparatus occurs simultaneously among all regular expressions or concepts as they are identified and is displayed within the matrix or visualization apparatus in real time as matches or hits among concepts or regular expressions. This master visualization apparatus displays patterns of intersections among all entered regular expressions with corresponding boxes of varying sizes displayed within the matrix or visualization matrix. The size of each box indicates the number of possible intersections between two or more regular expressions or concepts and develops a pattern of possible matches. By clicking on each box, the process produces a refined set of data displaying, in one example, only the relationships among queried terms or concepts and as input by the user. The grid may present visual information indicative of a timeline when documents containing co-occurrences were published.

The apparatus using a matrix generator and method thereof produces a matrix visualization of all possible and interesting intersections of data from among the entered key concepts. This refined data represents the essential elements of what the user is looking for.

The apparatus using an extractor and method thereof extracts files or records that are of interest for additional processing. Relevant documents of importance are sorted and any key data elements are automatically entered into a customized database for use by the client.

This information output is then handled in one of two ways:

The apparatus using a compiler and method thereof compiles the refined data in easily accessible databases that can be delivered, in real time, to a prospective client.

Data is entered into customized databases or sold to the client through an interface. The ability to query additional information sources to verify legal records, identify the location of mineral rights owners, recent sales of mineral rights, etc. or to cross reference important information is then possible.

The apparatus using a storage device and method thereof store output in either in-house servers or on site on a client's own secure server and can be accessed from TextOre's web site or server site for the clients' internal research purposes.

In another example, the text data is stored in a big-data distributed environment such as Hadoop HDFS, and rather than one TextOre scanner on one server reading all the data, the scanner executable is distributed to all nodes of the cluster and only the match list data is brought back to the TextOre server.

FIG. 19 is a diagram illustrating a sample of a finite state machine (FSM) 1900 that is used to mine the data to produce a match list. This example FSM matches four words: CAR, CART, CAT, and DOG. Each single letter scanned in the input determines a transition from one state node to another. However, characters not corresponding to any valid word result in an “other” transition such as transition 1920 that points back to the START state node 1910. For simplicity, all “other” transitions have been omitted; every state node has a transition for “all other characters” that points back to the START state node 1910, although only transition 1920 is illustrated. For example, if the document includes the word “CAT”, there will be a transition from START to state 1 based on the “C” at 1930, from state 1 to state 3 based on the “A”, and from state 3 to state 5 based on the “T”. State 5 includes concentric circles, because special “end” states are indicated by double circles. As another example, the word “CAR” is recognized based on transitions from state 1 to state 3 to state 6, but the word “CART” is recognized concurrently based on a transition from state 6 to state 8.

However, in other examples, an FSM is constructed to include more than simply successions between letters that form words. First, transitions may be designated to correspond to wildcards or alternate terms as well as simply lists of terms. Additionally, as discussed above, the nodes in the FSM include “end” state information related to boundaries of paragraphs and documents rather than just words, so that when words are identified they can be associated with paragraphs and documents so as to allow the determination of co-occurrences.

FIG. 20 is an example of how a match list is represented. In the example of FIG. 20, the match list is stored in XML. Here, a match list is denoted at the top level using the “<textore_match_list>” tag. However, successive levels of hierarch label “textore_document”, “textore_paragraph”, and “textore_keyword”. Furthermore, each keyword is associated with a “byte_start” and “byte_end” that mark its starting point and end. Furthermore, FIG. 20 illustrates that a single term may be used twice, as in the case of the term “bequest”. Thus, FIG. 20 has been populated with appearances of the terms “bequest” and “before” as well as information about their shared location in a single paragraph of a single document.

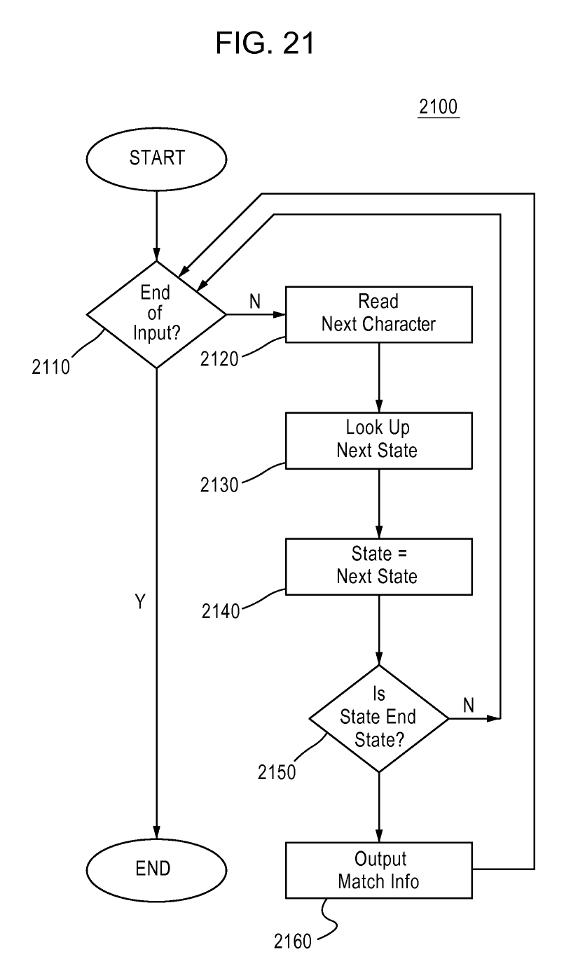

FIG. 21 is a flowchart 2100 illustrating the operational method of a scanner, according to an example. At operation 2110, the method determines if the end of input is reached. That is the scanner 1750 determines if there are additional characters to be processed in text data 1740. If not, the method is complete. If so, at operation 2120 the method reads the next character. At operation 2130, based on the character, the method looks up the next state. At operation 2140, the method sets the state of the FSM to the next state. At operation 2150, the method determines if the state is an end state. If so, at operation 2160, the method outputs the match information. Then, or if the state is not an end state, the method returns to operation 2110 to determine if additional input is available for further scanning. Thus, when the scanner 1750 has performed a complete pass through the text data 1740 that it processes, all end states have been recorded in the match list and hence no further scanning is necessary to derive co-occurrences, and a match list 1760 is available for use by the builder 1770.

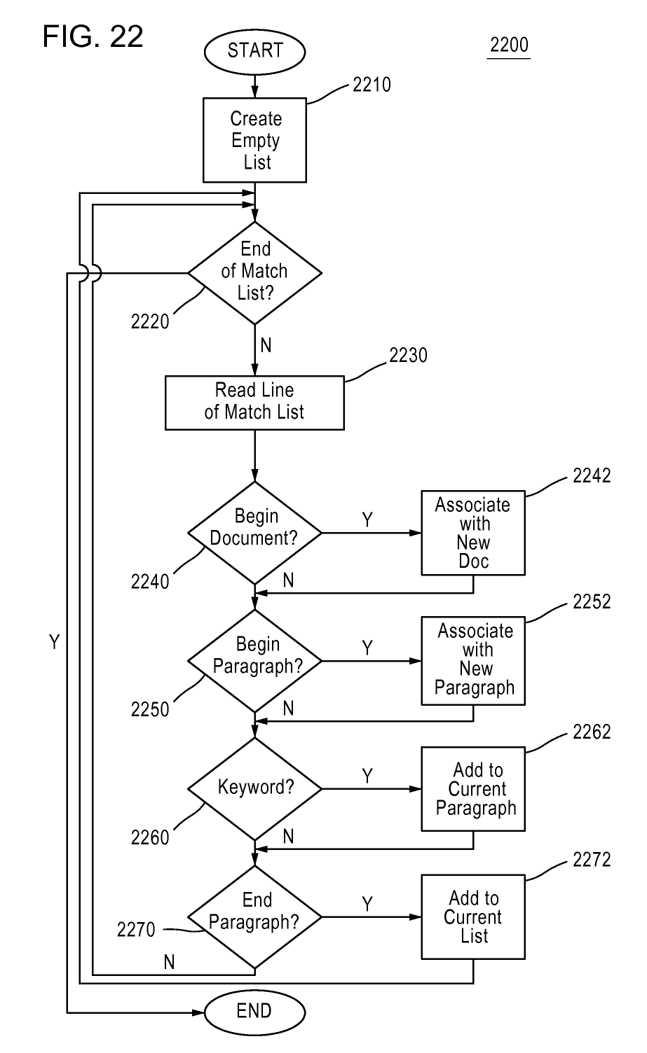

FIG. 22 is a flowchart 2200 illustrating the operational method of a builder, according to an example. The goal of the builder is to create a list of entries that can be tallied to provide information used to populate grids, such as those provided in FIG. 4 and FIG. 6. At operation 2210, the method creates an empty list for organizing the results of processing the match list 1760. At operation 2220, the method determines whether the end of the match list has been reached. If so, the method terminates. If not, at operation of 2230, the method reads the next line of the match list.

At operation 2240, the method determines whether the current line indicates the beginning of a document. If so, at operation 2242, the method associates the line with a new document.

At operation 2250, the method determines whether the current line indicates the beginning of a paragraph. If so, at operation 2252, the method associates the line with a new document.

At operation 2260, the method determines whether the current line indicates a keyword. If so, at operation 2262, the method adds the keyword to the current paragraph.

At operation 2270, the method determines whether the current line indicates the end of a paragraph. If so, at operation 2272, the method adds the paragraph to the current list.

After operation 2270 or operation 2272, the method returns to operation 2220 to determine if the end of the match list has been reached.

After the match list has been processed by the builder, the result will be a document that includes a set of paragraphs associated with tallies of co-occurrences between documents in those paragraphs.

The technology just described has a wide range of applications, where gathering a corpus of documents, mining the documents using TextOre technology, and visualizing the results of the mining provides useful information to a user. In the case of the energy market application, the key information that is being sought is all land deed, lease, and mineral rights information that is currently housed in county courthouses. With the help of one or a small number of subject matter experts or “landmen”, who are users with subject matter expertise, the apparatus and the method extract key words and phrases and pin-points them at the document level. From this point, a land deed user/expert reviews the apparatus' and the method's refined results and determines what is the most important or key information. Thus, examples are able to eliminate the use of large numbers of landmen who would otherwise be required to cull through large numbers of documents. Instead, examples provide a technological solution that only requires a limited use of subject matter experts.

The application of the ingested documents allows for mining text and extraction of key information. While examples have been presented for processing documents in the context of the energy field, other fields of use are possible that exploit the technologies used in examples. For example, the technology of examples is potentially relevant to the real estate title market. Because examples provide the capability to process through large quantities of text and find co-occurrences of related terms, it is possible to track incidences of legal terms and names of owning parties through successions of documents. As a result, by performing such tracking and using visualization and analysis techniques as presented with respect to the examples, it is possible to analyze the chain of title associated with a particular piece of property, such as real property. For example, the technologies presented offer the potential to help generate “run sheets” that are helpful in tracking ownership of properties and help in establishing that a title is “clean” and uncontested.

An interface is configured to quickly sift through massive sets of documents and cull from them information related to a corpus of key words and phrases and is then run against a database of relevant documents. A visualization of the interface is illustrated in certain figures, such as FIGS. 4 and 6.

The matrix is a visualization interface that allows a user to see all the possible cross-sections of their specific searches. For example, the matrix shows the user how many times the word “lease” intersects with the word “oil” and in how many documents. This visualization is completed down to the paragraph level in order to pin-point the most valuable information to the user.

The matrix also shows the user how many times the word “lease” intersects with the word “oil” and in how many documents. This is completed down to the paragraph level in order to pinpoint the most valuable information to the user.

On the article list page, links are configured to enable a person to see the document section, such as a paragraph, where the two search terms were found. Also, the full document text can be viewed, with a link to the original PDF. The article list may be filtered by source, date and other key parameters. A results matrix is a “map” of all intersections between two search terms found in the document set being mined. For instance, one cell in the matrix indicates hits in documents for the terms “deed” and “transfer”. By clicking on a link in that cell, the user will be able to go to a list of all documents where that intersection was identified by the apparatus and the method and determine the most important/relevant document to be selected.

In accordance with an illustrative configuration, a customized database is configured to include the ability to extract specified data elements for compilation in database formats to include Microsoft Excel, Microsoft Access, SQL and MySQL, etc. For example, in the energy field, specific data items of interest for inclusion in this database are 1) Names of title owners; 2) Land deeds; 3) Ownership of mineral rights; 4) Tract Size; 5) GPS coordinates of metes and bounds; 6) Assignment of title; 7) Assignment of mineral assets/rights; 8) Physical improvements; 9) Roads; 10) Contiguous properties; 11) Taxes.

The examples of a data mining apparatus and method may improve the speed of data mining by providing the capability to extract information about co-occurrences of terms in a corpus in a single, unified processing pass, rather than requiring multiple passes to identify co-occurrences.

In an interface, information is potentially presented using an image display apparatus. The image display apparatus may be implemented as a liquid crystal display (LCD), a light-emitting diode (LED) display, a plasma display panel (PDP), a screen, a terminal, and the like. A screen may be a physical structure that includes one or more hardware components that provide the ability to render a user interface and/or receive user input. The screen can encompass any combination of display region, gesture capture region, a touch sensitive display, and/or a configurable area. The screen can be embedded in the hardware or may be an external peripheral device that may be attached and detached from the apparatus. The display may be a single-screen or a multi-screen display. A single physical screen can include multiple displays that are managed as separate logical displays permitting different content to be displayed on separate displays although part of the same physical screen.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a hardware component may include multiple processors or a processor and a controller. In addition, different processing configurations are possible, such as parallel processors.

The methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The media may also include, alone or in combination with the software program instructions, data files, data structures, and the like. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

As a non-exhaustive illustration only, a terminal/device/unit described herein may refer to mobile devices such as, for example, a cellular phone, a smart phone, a wearable smart device (such as, for example, a ring, a watch, a pair of glasses, a bracelet, an ankle bracket, a belt, a necklace, an earring, a headband, a helmet, a device embedded in the cloths or the like), a personal computer (PC), a tablet personal computer (tablet), a phablet, a personal digital assistant (PDA), a digital camera, a portable game console, an MP3 player, a portable/personal multimedia player (PMP), a handheld e-book, an ultra mobile personal computer (UMPC), a portable lab-top PC, a global positioning system (GPS) navigation, and devices such as a high definition television (HDTV), an optical disc player, a DVD player, a Blu-ray player, a setup box, or any other device capable of wireless communication or network communication consistent with that disclosed herein. In a non-exhaustive example, the wearable device may be self-mountable on the body of the user, such as, for example, the glasses or the bracelet. In another non-exhaustive example, the wearable device may be mounted on the body of the user through an attaching device, such as, for example, attaching a smart phone or a tablet to the arm of a user using an armband, or hanging the wearable device around the neck of a user using a lanyard.

A computing system or a computer may include a microprocessor that is electrically connected to a bus, a user interface, and a memory controller, and may further include a flash memory device. The flash memory device may store N-bit data via the memory controller. The N-bit data may be data that has been processed and/or is to be processed by the microprocessor, and N may be an integer equal to or greater than 1. If the computing system or computer is a mobile device, a battery may be provided to supply power to operate the computing system or computer. It will be apparent to one of ordinary skill in the art that the computing system or computer may further include an application chipset, a camera image processor, a mobile Dynamic Random Access Memory (DRAM), and any other device known to one of ordinary skill in the art to be included in a computing system or computer. The memory controller and the flash memory device may constitute a solid-state drive or disk (SSD) that uses a non-volatile memory to store data.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A data mining method comprising:
receiving a keyword list;
compiling the keyword list into a finite state machine (FSM);
performing data mining on documents in a document repository using a scanner, wherein the scanner uses the FSM to produce a match list comprising information about locations of the keywords in the documents; and
processing the match list to produce a grid document comprising information about co-occurrences of keywords from the list in the documents.

2. The method of claim 1, wherein the keyword list comprises regular expressions.

3. The method of claim 1, wherein the compiling comprises transforming the keyword list into FSM bytecode and storing a representation of the FSM in memory based on the bytecode.

4. The method of claim 1, wherein the scanner uses the FSM to produce a match list by processing each character in the documents to follow transitions in the FSM, and outputs match information when the current state in the FSM is an end state.

5. The method of claim 4, wherein an end state indicates a keyword boundary, a paragraph boundary, or a document boundary.

6. The method of claim 4, wherein the match information includes location information about where in the documents the match occurred.

7. The method of claim 1, wherein the processing of the match list comprises generating a list of co-occurrences and counts co-occurrences to generate information for the grid.

8. The method of claim 7, wherein the grid presents visual information indicative of the level of frequency of co-occurrences between keywords from the keyword list.

9. The method of claim 7, wherein the grid includes graphical elements that provide a user with links to locations in the documents where co-occurrences occur.

10. The method of claim 1, wherein the scanner requires only a single pass through the documents to produce the match list.

11. A data mining apparatus comprising:
a compiler configured to receive a keyword list and to compile the keyword list into a finite state machine (FSM);
a scanner configured to perform data mining on documents in a document repository, wherein the scanner uses the FSM to produce a match list comprising information about locations of the keywords in the documents; and
a builder configured to process the match list to produce a grid document comprising information about co-occurrences of keywords from the list in the documents.

12. The apparatus of claim 11, wherein the keyword list comprises regular expressions.

13. The apparatus of claim 11, wherein the compiler transforms the keyword list into FSM bytecode and stores a representation of the FSM in memory based on the bytecode.

14. The apparatus of claim 11, wherein the scanner uses the FSM to produce a match list by processing each character in the documents to follow transitions in the FSM, and outputs match information when the current state in the FSM is an end state.

15. The apparatus of claim 14, wherein an end state indicates a keyword boundary, a paragraph boundary, or a document boundary.

16. The apparatus of claim 14, wherein the match information includes location information about where in the documents the match occurred.

17. The apparatus of claim 11, wherein the builder processes the match list to generate a list of co-occurrences and counts co-occurrences to generate information for the grid.

18. The apparatus of claim 17, wherein the grid presents visual information indicative of the level of frequency of co-occurrences between keywords from the keyword list.

19. The apparatus of claim 17, wherein the grid includes graphical elements that provide a user with links to locations in the documents where co-occurrences occur.

20. A non-transitory computer-readable storage medium storing a program for data mining, the program comprising instructions for causing a processor to perform the method of claim 1.
